(19) United States
(12) Patent Application Publication
(10) Pub. No.: US 2026/0238991 A1
(43) Pub. Date: Aug. 13, 2026

(54) METHODS TO SIGNAL UE-ASSOCIATED TYPES OF AVAILABLE AI/ML ASSISTANCE INFORMATION

(71) Applicant: Telefonaktiebolaget LM Ericsson (publ), Stockholm (SE)

(72) Inventors: Pablo Soldati, Solna (SE); Luca Lunardi, Genova (IT)

(21) Appl. No.: 19/155,304

(22) PCT Filed: Feb. 9, 2024
(86) PCT No.: PCT/EP2024/053342

§ 371 Date: Aug. 11, 2025

Related U.S. Application Data
(60) Provisional application No. 63/485,076, filed on Feb. 15, 2023.
(60) Provisional application No. 63/487,048, filed on Feb. 27, 2023.

(51) Int. Cl. H04W 8/24

(52) U.S. Cl. CPC H04W 8/24

(57) ABSTRACT

Systems and methods related to signaling User Equipment (UE)-assisted types of available assistance information (e.g., Artificial Intelligence (AI) or Machine Learning (ML) assistance information). In one embodiment, a method performed by a UE comprises sending, to a network node, information that indicates one or more UE-associated types of available AI or ML assistance information that are available from the UE. In this manner, signaling overhead between the UE and the network node to configure an exchange of AI/ML assistance information may be reduced.

### RELATED APPLICATIONS

This application claims the benefit of provisional patent application Ser. No. 63/485,076, filed Feb. 15, 2023 and provisional patent application Ser. No. 63/487,048, filed Feb. 27, 2023, the disclosures of which are hereby incorporated herein by reference in their entireties.

### TECHNICAL FIELD

The present disclosure relates to a cellular communications system and, more specifically, systems and methods for indication of availability of User Equipment (UE) associated types of Artificial Intelligence (AI) or Machine Learning (ML) assistance information.

### BACKGROUND

The current 5^{th} Generation (5G) Radio Access Network (RAN) (also referred to as the Next Generation RAN (NG-RAN)) architecture is depicted in FIG. 1 and described in 3^{rd} Generation Partnership Project (3GPP) Technical Specification (TS) 38.401 v17.2.0 as follows. The NG-RAN consists of a set of gNodeBs (gNBs) connected to the 5G Core (5GC) through the (Next Generation) NG interface. As specified in 3GPP TS 38.300 v17.3.0, NG-RAN could also include a set of next generation eNodeBs (ng-eNBs), where an ng-eNB may consist of an ng-eNB-Central Unit (CU) and one or more ng-eNB-Distributed Units (DUs). An ng-eNB-CU and an ng-eNB-DU is connected via W1 interface. The general principle described here also applies to ng-eNB and W1 interface, if not explicitly specified otherwise.
An gNB can support Frequency Division Duplexing (FDD) mode, Time Division Duplexing (TDD) mode, or dual mode operation.
gNBs can be interconnected through the Xn interface.
A gNB may consist of a gNB-CU and one or more gNB-DU(s). A gNB-CU and a gNB-DU is connected via F1 interface.
One gNB-DU is connected to only one gNB-CU.
NG, Xn, and F1 are logical interfaces.

For NG-RAN, the NG and Xn-C interfaces for a gNB consisting of a gNB-CU and gNB-DUs terminate in the gNB-CU. For Evolved Universal Terrestrial Radio Access (EUTRA)-New Radio (NR) Dual Connectivity (EN-DC), the S1-U and X2-C interfaces for a gNB consisting of a gNB-CU and gNB-DUs terminate in the gNB-CU. The gNB-CU and connected gNB-DUs are only visible to other gNBs and the 5GC as a gNB. A possible deployment scenario is described in Annex A of 3GPP TS 38.401.

The node hosting user plane part of the NR Packet Data Convergence Protocol (PDCP) (e.g. gNB-CU, gNB-CU-User Plane (UP), and for EN-DC, Master eNB (MeNB) or SgNB depending on the bearer split) performs user inactivity monitoring and further informs its inactivity or (re)activation to the node having the control plane (C-plane) connection towards the core network (e.g. over E1, X2). The node hosting NR Radio Link Control (RLC) (e.g., gNB-DU) may perform user inactivity monitoring and further inform its inactivity or (re)activation to the node hosting control plane, e.g. gNB-CU or gNB-CU-Control Plane (CP).

Uplink (UL) PDCP configuration (i.e. how the User Equipment (UE) uses the UL at the assisting node) is indicated via X2-C (for EN-DC), Xn-C (for NG-RAN) and F1-C. Radio Link Outage/Resume for downlink (DL) and/or UL is indicated via X2-U (for EN-DC), Xn-U (for NG-RAN), and F1-U.

The NG-RAN is layered into a Radio Network Layer (RNL) and a Transport Network Layer (TNL).

The NG-RAN architecture, i.e. the NG-RAN logical nodes and interfaces between them, is defined as part of the RNL. For each NG-RAN interface (NG, Xn, F1) the related TNL protocol and the functionality are specified. The TNL provides services for user plane transport, signaling transport.

It needs to be mentioned that the architecture shown in FIG. 1 is what 3GPP has defined for 5G. Other standardization groups, such as the Open RAN (ORAN), have further extended the architecture above and have for example split the gNB-DU into two further nodes connected by a fronthaul interface. The lower node of the split gNB-DU would contain the PHY protocol and the radio frequency (RF) parts, the upper node of the split gNB-DU would host the RLC and Medium Access Control (MAC). In ORAN the upper node is called O-DU, while the lower node is called O-Radio Unit (RU).

At the current state-of-art, the coordination across RAN and Transport domains is typically managed in non-real-time mode (e.g., pre-planning and provisioning the Transport domain) with the alternative being to coordinate Radio and Transport domains at the Service Orchestration level. However, no products are yet available on the market.

In case of dynamic changes in the allocated RAN capacity, it should be possible to optimize the Transport capacity accordingly. Mobility Load Balancing is envisaged as one of the use cases where tighter coordination between RAN and Transport is required. It is also noted that the transport network is a contributor to the overall latency and resilience of the mobile services, and this aspect is particularly important in the case of Ultra-Reliable Low-Latency Communication (URLLC) services according to 3GPP standard specification.

The 3GPP RAN3 Study Item (SI) “Study on enhancement for data collection for NR and EN-DC” studied general high-level principles, functional framework, and potential use cases for Artificial Intelligence (AI)-enabled RAN. The accomplishments of the study are documented in 3GPP Technical Report (TR) 37.817 v17.0.0. The normative work based on the conclusion of Rel-17 SI is currently undertaken in 3GPP Rel-18, and the related Work Item (WI) is described in RP-213602.

The following agreements were made at RAN3#117bis-e:
Signaling describing the capability to support specific information predictions used for AI/Machine Learning (ML) is not pursued in this release;
Signaling describing the capability to supports specific AI/ML use cases is not pursued in this release;
AI/ML capability exchange in NG-RAN can be achieved by means of procedures for AI/ML information request, AI/ML information response and AI/ML Information Request Failure.

The 3GPP RAN1 Working Group is currently working on a SI on AI/ML for NR Air Interface. A description of the objectives of this can be found in RP-213599.

### SUMMARY

It is an object of the disclosure to provide systems and methods related to signaling User Equipment (UE)-assisted types of available assistance information (e.g., Artificial Intelligence (AI) or Machine Learning (ML) assistance information). In one embodiment, a method performed by a UE comprises sending, to a network node, information that indicates one or more UE-associated types of available AI or ML assistance information that are available from the UE. In this manner, signaling overhead between the UE and the network node to configure an exchange of AI/ML assistance information may be reduced.

In one embodiment, the method further comprises receiving, from a network node, a request to provide UE-associated AI or ML assistance information within at least one of the one or more UE-associated types of available AI or ML assistance information. In one embodiment, the method further comprises, responsive to receiving the request, sending the requested UE-associated AI or ML assistance information to the network node.

In one embodiment, the one or more UE-associated types of available AI or ML assistance information comprises one or more of the following:
information that indicates that the UE is able to provide one or more certain predictions
information that indicates that the UE is able to support providing training data for an AI/ML model
information that indicates that the UE is able to support training or re-training an AI/ML model
information that indicates that the UE is able to support validating (or participate in validating) an AI/ML model
information that indicates that the UE is able to support authenticating (or participate in authenticating) an AI/ML model
information that indicates that the UE is able to support participating in executing an AI/ML model
information that indicates that the UE is able to support (up to) a certain number of hidden layers in neural network AI/ML models
information that indicates that the UE is able to support providing a certain number (e.g., a maximum number) of hidden units/nodes per hidden layer of the for a certain type of AI/ML model
information that indicates that the UE is able to support specific types of AI/ML models (e.g., feed-forward neural networks, convolutional neural networks, recurrent neural networks, graph neural networks, attention models, autoencoders, etc.)
information that indicates that the UE is able to support specific types of AI/ML algorithms (e.g., supervised learning, unsupervised learning, reinforcement learning, federated learning, etc.)
information that indicates that the UE is able to support certain AI/ML use cases or AI/ML based network operations
information that indicates that the UE is able to support joint AI/ML operation between the UE and a network node
information that indicates that the UE is able to support certain collaboration levels between the UE and a network node
information that indicates that the UE is able to support certain AI/ML model training strategy(ies)
information that indicates that the UE is able to support partial AI/ML model training at UE side or network side
information that indicates that the UE is able to support inference of certain information
information that indicates that the UE is able to support use of certain inferred information
information that indicates that the UE is able to support periodic/aperiodic feedback assistance information (e.g., for AI/ML model monitoring)
information that indicates that the UE is able to support testing Life Cycle Management (LCM)
information that indicates that the UE is able to support LCM procedures such as:
activation/deactivation of AI/ML model, switching between AI/ML models, fallback to one AI/ML model, registration of an AI/ML model, updates of an AI/ML model
information that indicates that the UE is able to support operations/procedures/functionalities related to AI/ML at UE Access Stratum
information that indicates that the UE is able to support operations/procedures/functionalities related to AI/ML at UE Non-Access Stratum
information that indicates that the UE is able to support operations/procedures/functionalities related to AI/ML at UE Application layer
information that indicates that the UE is able to support providing feedback for an action triggered/recommended by an AI/ML model
information that indicates that the UE is able to support providing positioning labels in relation to AI/ML data samples
information that indicates that the UE is able to support providing timestamps labels in relation to AI/ML data samples.

In one embodiment, sending the information that indicates the one or more UE-associated types of available AI or ML assistance information comprises sending the information in one or more Radio Resource Control (RRC) messages. In one embodiment, the one or more RRC messages comprise one or more of the following: an RRC Resume Complete message, an RRC Setup Complete message, an RRC Reconfiguration Complete message, an RRC Reestablishment Complete message, an UE Capability Information message, and Uplink Information Transfer message, an UE Information Response message, an UE Assistance Information message, a Measurement Report message, a Measurement Report Application Layer message, and/or an Uplink Information Transfer Multi-Radio Access Technology (RAT) Dual Connectivity (MR-DC) message.

In one embodiment, the method further comprises receiving, from the network node, a request for the information that indicates the one or more UE-associated types of available AI or ML assistance information, wherein sending the information that indicates the one or more UE-associated types of available AI or ML assistance information comprise sending the information to the network node in response to receiving the request.

In one embodiment, the method further comprises sending, to the network node, an indication of availability of the information that indicates the one or more UE-associated types of available AI or ML assistance information. In one embodiment, sending the indication comprises sending the indication comprised in an uplink message of an RRC Connection Establishment procedure, an RRC Connection Resume procedure, an RRC Connection Re-establishment procedure, an RRC Connection Reconfiguration procedure, a Measurement Report procedure, an Application layer measurement reporting procedure, a UE Information procedure, an uplink (UL) Information Transfer procedure, an UL information transfer for MR-DC procedure, a UE Capability transfer procedure, or a UE Assistance Information procedure. In one embodiment, sending the indication comprises sending the indication comprised in an RRC message, such as, e.g., an RRC Resume Complete message, an RRC Resume Request, an RRC Setup Complete message, an RRC Setup Request message, an RRC Reconfiguration Complete message, an RRC Reestablishment Complete message, an UE Capability Information message, and Uplink Information Transfer message, an UE Information Response message, an UE Assistance Information message, a Measurement Report message, a Measurement Report Application Layer message, or an Uplink Information Transfer MR-DC message.

In one embodiment, the method further comprises receiving, from a second network node, a request for the information that indicates the one or more UE-associated types of available AI or ML assistance information, and sending the information that indicates the one or more UE-associated types of available AI or ML assistance information to the second network node in response to receiving the request from the second network node.

In one embodiment, the method further comprises sending the information that indicates the one or more UE-associated types of available AI or ML assistance information to a second network node.

Corresponding embodiments of a UE are also disclosed.

Embodiments of a method performed by a first network node are also disclosed. In one embodiment, a method performed by a first network node comprises receiving, from a UE, information that indicates one or more UE-associated types of available Artificial Intelligence, AI, or Machine Learning, ML, assistance information that are available from the UE.

In one embodiment, the method further comprising sending, to the UE, a request to provide UE-associated AI or ML assistance information within at least one of the one or more UE-associated types of available AI or ML assistance information. In one embodiment, the method further comprises, responsive to sending the request, receiving the requested UE-associated AI or ML assistance information from the UE.

In one embodiment, the one or more UE-associated types of available AI or ML assistance information comprises one or more of the following:
information that indicates that the UE is able to provide one or more certain predictions
information that indicates that the UE is able to support providing training data for an AI/ML model
information that indicates that the UE is able to support training or re-training an AI/ML model
information that indicates that the UE is able to support validating (or participate in validating) an AI/ML model
information that indicates that the UE is able to support authenticating (or participate in authenticating) an AI/ML model
information that indicates that the UE is able to support participating in executing an AI/ML model
information that indicates that the UE is able to support (up to) a certain number of hidden layers in neural network AI/ML models
information that indicates that the UE is able to support providing a certain number (e.g., a maximum number) of hidden units/nodes per hidden layer of the for a certain type of AI/ML model
information that indicates that the UE is able to support specific types of AI/ML models (e.g., feed-forward neural networks, convolutional neural networks, recurrent neural networks, graph neural networks, attention models, autoencoders, etc.)
information that indicates that the UE is able to support specific types of AI/ML algorithms (e.g., supervised learning, unsupervised learning, reinforcement learning, federated learning, etc.)
information that indicates that the UE is able to support certain AI/ML use cases or AI/ML based network operations
information that indicates that the UE is able to support joint AI/ML operation between the UE and a network node
information that indicates that the UE is able to support certain collaboration levels between the UE and a network node
information that indicates that the UE is able to support certain AI/ML model training strategy(ies)
information that indicates that the UE is able to support partial AI/ML model training at UE side or network side
information that indicates that the UE is able to support inference of certain information
information that indicates that the UE is able to support use of certain inferred information
information that indicates that the UE is able to support periodic/aperiodic feedback assistance information (e.g., for AI/ML model monitoring)
information that indicates that the UE is able to support testing Life Cycle Management (LCM)
information that indicates that the UE is able to support LCM procedures such as:
activation/deactivation of AI/ML model, switching between AI/ML models, fallback to one AI/ML model, registration of an AI/ML model, updates of an AI/ML model
information that indicates that the UE is able to support operations/procedures/functionalities related to AI/ML at UE Access Stratum
information that indicates that the UE is able to support operations/procedures/functionalities related to AI/ML at UE Non-Access Stratum
information that indicates that the UE is able to support operations/procedures/functionalities related to AI/ML at UE Application layer
information that indicates that the UE is able to support providing feedback for an action triggered/recommended by an AI/ML model
information that indicates that the UE is able to support providing positioning labels in relation to AI/ML data samples
information that indicates that the UE is able to support providing timestamps labels in relation to AI/ML data samples.

In one embodiment, receiving the information that indicates the one or more UE-associated types of available AI or ML assistance information comprises receiving the information in one or more RRC messages. In one embodiment, the one or more RRC messages comprise one or more of the following: an RRCResumeComplete message, an RRCSetupComplete message, an RRCReconfigurationComplete message, an RRCReestablishmentComplete message, an UECapabilityInformation message, an UplinkInformationTransfer message, an UEInformationResponse message, an UEAssistanceInformation message, a MeasurementReport message, a MeasurementReportAppLayer message, and/or an Uplink Information Transfer MR-DC message.

In one embodiment, the method further comprises sending, to the UE, a request for the information that indicates the one or more UE-associated types of available AI or ML assistance information, wherein receiving the information that indicates the one or more UE-associated types of available AI or ML assistance information comprise receiving the information from the UE in response to sending the request.

In one embodiment, the method further comprises receiving, from the UE, an indication of availability of the information that indicates the one or more UE-associated types of available AI or ML assistance information. In one embodiment, receiving the indication comprises receiving the indication comprised in an uplink message of an RRC Connection Establishment procedure, an RRC Connection Resume procedure, an RRC Connection Re-establishment procedure, an RRC Connection Reconfiguration procedure, a Measurement Report procedure, a UE Information procedure, an UL Information Transfer procedure, an UL information transfer for MR-DC procedure, a UE Capability transfer procedure, or a UE Assistance Information procedure. In one embodiment, receiving the indication comprises receiving the indication comprised in an RRC message such as, e.g., an RRCResumeComplete message, an RRCResumeRequest message, an RRCResumeRequest1 message, an RRCSetupComplete message, an RRCSetupRequest message, an RRCReconfigurationComplete message, an RRCReestablishmentComplete message, an UECapabilityInformation message, and UplinkInformationTransfer message, an UEInformationResponse message, an UEAssistanceInformation message, a MeasurementReport message, a MeasurementReportAppLayer message, or an UplinkInformationTransferMRDC message.

In one embodiment, the method further comprises sending, to a second network node, the information that indicates the one or more UE-associated types of available AI or ML assistance information available from the UE. In one embodiment, the method further comprises receiving, from the second network node, a request for the information that indicates the one or more UE-associated types of available AI or ML assistance information, wherein sending the information that indicates the one or more UE-associated types of available AI or ML assistance information to the second network node comprises sending the information that indicates the one or more UE-associated types of available AI or ML assistance information to the second network node in response to receiving the request from the second network node. In one embodiment, the method further comprises sending, to the second network node, an indication of availability of the information that indicates the one or more UE-associated types of available AI or ML assistance information.

In one embodiment, the method further comprises sending, to a second network node during a mobility, or conditional mobility, or multi-connectivity for the UE, a message (e.g., a handover request message) comprising an indication of availability of the information that indicates the one or more UE-associated types of available AI or ML assistance information available from the UE. In one embodiment, the method further comprises receiving, from the second network node, a second message (e.g., handover acknowledgement message) comprising a request for the information that indicates the one or more UE-associated types of available AI or ML assistance information available from the UE.

Corresponding embodiments of a first network node are also disclosed.

Embodiments of a method performed by a second network node are also disclosed. In one embodiment, a method performed by a second network node comprises receiving, from a first network node, information that indicates one or more UE-associated types of available AI or ML assistance information that are available from a UE.

In one embodiment, the one or more UE-associated types of available AI or ML assistance information comprises one or more of the following:
information that indicates that the UE is able to provide one or more certain predictions
information that indicates that the UE is able to support providing training data for an AI/ML model
information that indicates that the UE is able to support training or re-training an AI/ML model
information that indicates that the UE is able to support validating (or participate in validating) an AI/ML model
information that indicates that the UE is able to support authenticating (or participate in authenticating) an AI/ML model
information that indicates that the UE is able to support participating in executing an AI/ML model
information that indicates that the UE is able to support (up to) a certain number of hidden layers in neural network AI/ML models
information that indicates that the UE is able to support providing a certain number (e.g., a maximum number) of hidden units/nodes per hidden layer of the for a certain type of AI/ML model
information that indicates that the UE is able to support specific types of AI/ML models (e.g., feed-forward neural networks, convolutional neural networks, recurrent neural networks, graph neural networks, attention models, autoencoders, etc.)
information that indicates that the UE is able to support specific types of AI/ML algorithms (e.g., supervised learning, unsupervised learning, reinforcement learning, federated learning, etc.)
information that indicates that the UE is able to support certain AI/ML use cases or AI/ML based network operations
information that indicates that the UE is able to support joint AI/ML operation between the UE and a network node
information that indicates that the UE is able to support certain collaboration levels between the UE and a network node
information that indicates that the UE is able to support certain AI/ML model training strategy(ies)
information that indicates that the UE is able to support partial AI/ML model training at UE side or network side
information that indicates that the UE is able to support inference of certain information
information that indicates that the UE is able to support use of certain inferred information
information that indicates that the UE is able to support periodic/aperiodic feedback assistance information (e.g., for AI/ML model monitoring)
information that indicates that the UE is able to support testing Life Cycle Management (LCM)
information that indicates that the UE is able to support LCM procedures such as:
activation/deactivation of AI/ML model, switching between AI/ML models, fallback to one AI/ML model, registration of an AI/ML model, updates of an AI/ML model
information that indicates that the UE is able to support operations/procedures/functionalities related to AI/ML at UE Access Stratum
information that indicates that the UE is able to support operations/procedures/functionalities related to AI/ML at UE Non-Access Stratum
information that indicates that the UE is able to support operations/procedures/functionalities related to AI/ML at UE Application layer
information that indicates that the UE is able to support providing feedback for an action triggered/recommended by an AI/ML model
information that indicates that the UE is able to support providing positioning labels in relation to AI/ML data samples
information that indicates that the UE is able to support providing timestamps labels in relation to AI/ML data samples.

In one embodiment, the method further comprises sending, to the first network node, a request for the information that indicates the one or more UE-associated types of available AI or ML assistance information, wherein receiving the information that indicates the one or more UE-associated types of available AI or ML assistance information comprise receiving the information from the first network node in response to sending the request. In one embodiment, the method further comprises receiving, from the first network node, an indication of availability of the information that indicates the one or more UE-associated types of available AI or ML assistance information that are available from the UE.

In one embodiment, a method performed by a second network node comprises receiving, from a first network node during a mobility, or conditional mobility, or multi-connectivity procedure for a UE, an indication of availability of information that indicates one or more UE-associated types of available AI or ML assistance information that are available from a UE.

In one embodiment, the method further comprises, prior to receiving the indication, sending to the first network node, during the mobility, or conditional mobility, or multi-connectivity procedure for the UE, a request for the information that indicates the one or more UE-associated types of available AI or ML assistance information that are available from a UE.

In one embodiment, the one or more UE-associated types of available AI or ML assistance information comprises one or more of the following:
information that indicates that the UE is able to provide one or more certain predictions
information that indicates that the UE is able to support providing training data for an AI/ML model
information that indicates that the UE is able to support training or re-training an AI/ML model
information that indicates that the UE is able to support validating (or participate in validating) an AI/ML model
information that indicates that the UE is able to support authenticating (or participate in authenticating) an AI/ML model
information that indicates that the UE is able to support participating in executing an AI/ML model
information that indicates that the UE is able to support (up to) a certain number of hidden layers in neural network AI/ML models
information that indicates that the UE is able to support providing a certain number (e.g., a maximum number) of hidden units/nodes per hidden layer of the for a certain type of AI/ML model
information that indicates that the UE is able to support specific types of AI/ML models (e.g., feed-forward neural networks, convolutional neural networks, recurrent neural networks, graph neural networks, attention models, autoencoders, etc.)
information that indicates that the UE is able to support specific types of AI/ML algorithms (e.g., supervised learning, unsupervised learning, reinforcement learning, federated learning, etc.)
information that indicates that the UE is able to support certain AI/ML use cases or AI/ML based network operations
information that indicates that the UE is able to support joint AI/ML operation between the UE and a network node
information that indicates that the UE is able to support certain collaboration levels between the UE and a network node
information that indicates that the UE is able to support certain AI/ML model training strategy(ies)
information that indicates that the UE is able to support partial AI/ML model training at UE side or network side
information that indicates that the UE is able to support inference of certain information
information that indicates that the UE is able to support use of certain inferred information
information that indicates that the UE is able to support periodic/aperiodic feedback assistance information (e.g., for AI/ML model monitoring)
information that indicates that the UE is able to support testing Life Cycle Management (LCM)
information that indicates that the UE is able to support LCM procedures such as:
activation/deactivation of AI/ML model, switching between AI/ML models, fallback to one AI/ML model, registration of an AI/ML model, updates of an AI/ML model
information that indicates that the UE is able to support operations/procedures/functionalities related to AI/ML at UE Access Stratum
information that indicates that the UE is able to support operations/procedures/functionalities related to AI/ML at UE Non-Access Stratum
information that indicates that the UE is able to support operations/procedures/functionalities related to AI/ML at UE Application layer
information that indicates that the UE is able to support providing feedback for an action triggered/recommended by an AI/ML model
information that indicates that the UE is able to support providing positioning labels in relation to AI/ML data samples
information that indicates that the UE is able to support providing timestamps labels in relation to AI/ML data samples.

In one embodiment, the method further comprises sending, to the UE, a request for the information that indicates the one or more UE-associated types of available AI or ML assistance information available from the UE, and receiving the information that indicates the one or more UE-associated types of available AI or ML assistance information from the UE in response to sending the request.

In one embodiment, the method further comprises sending, to the first network node, a message comprising a request for the information that indicates the one or more UE-associated types of available AI or ML assistance information available from the UE, and receiving the information that indicates the one or more UE-associated types of available AI or ML assistance information from the UE in response to sending the request.

In one embodiment, a method performed by a second network node comprises receiving, from a first network node during a mobility, or conditional mobility, or multi-connectivity procedure for a UE, an indication of availability of information that indicates one or more UE-associated types of AI or ML assistance information that are available from the UE, and sending, to the UE, a request for UE-associated types of available AI or ML assistance information that are available from the UE.

Corresponding embodiments of a second network node are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the Next Generation Radio Access Network (NG-RAN) architecture as defined in 3^{rd} Generation Partnership Project (3GPP) specifications.

FIG. 2 illustrates one example embodiment of a first variant of the present disclosure.

FIG. 3 illustrates one example embodiment of a second variant of the present disclosure.

FIG. 4 illustrates one example embodiment of a third variant of the present disclosure.

FIG. 5 illustrates one example embodiment of a fourth variant of the present disclosure.

FIG. 6 illustrates one example embodiment of a fifth variant of the present disclosure.

FIG. 7 is an illustration of a possible realization of a sixth variant, where signaling from a mobility procedure, such as handover are partly reused to indicate to the second network node (e.g., the target node of a mobility handover) the availability of User Equipment (UE)-associated types of Artificial Intelligence (AI)/Machine Learning (ML) assistance information for the user device that is being handed over to the second network node.

FIG. 8 is an illustration of a possible realization of a seventh variant where signaling from a conditional mobility or conditional multi-connectivity procedure, such as conditional handover are partly reused to indicate to the second network node (e.g., the target node of a mobility handover) the availability of UE-associated types of AI/ML assistance information for the user device that is being handed over to the second network node, and the second network node reconfigures the UE and includes a request to provide UE-associated types of available AI/ML assistance information.

FIG. 9 is an illustration of a possible realization of an eighth variant where signaling from a conditional mobility or conditional multi-connectivity procedure, such as conditional handover are partly reused to indicate to the second network node (e.g., the target node of a mobility handover) the availability of UE-associated types of AI/ML assistance information for the user device that is being handed over to the second network node. The second network node requests the UE to provide UE-associated types of available AI/ML assistance information after the conditional procedure is completed.

FIG. 10 illustrates one example of a cellular communications system according to some embodiments of the present disclosure.

FIG. 11 is a schematic block diagram of a radio access node according to some embodiments of the present disclosure.

FIG. 12 is a schematic block diagram that illustrates a virtualized embodiment of the radio access node of FIG. 11 according to some embodiments of the present disclosure.

FIG. 13 is a schematic block diagram of the radio access node of FIG. 11 according to some other embodiments of the present disclosure.

FIG. 14 is a schematic block diagram of a UE according to some embodiments of the present disclosure.

FIG. 15 is a schematic block diagram of the UE of FIG. 14 according to some other embodiments of the present disclosure.

FIG. 16 illustrates a telecommunication network connected via an intermediate network to a host computer in accordance with some embodiments of the present disclosure.

FIG. 17 is a generalized block diagram of a host computer communicating via a base station with a UE over a partially wireless connection in accordance with some embodiments of the present disclosure.

FIG. 18 is a flowchart illustrating a method implemented in a communication system in accordance with one embodiment of the present disclosure.

FIG. 19 is a flowchart illustrating a method implemented in a communication system in accordance with one embodiment of the present disclosure.

FIG. 20 is a flowchart illustrating a method implemented in a communication system in accordance with one embodiment of the present disclosure.

FIG. 21 is a flowchart illustrating a method implemented in a communication system in accordance with one embodiment of the present disclosure.

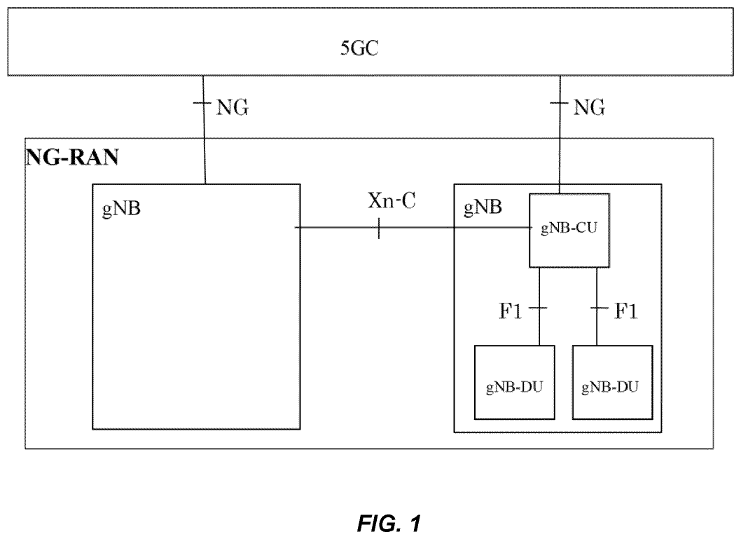

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Note the following about some terminology used in the description provided herein:
As used herein, a network node can be a Radio Access Network (RAN) node, an Operations, Administration, and Maintenance (OAM), a Core Network node, an Service Management and Orchestration (SMO), a Network Management System (NMS), a Non-Real Time RAN Intelligent Controller (Non-RT RIC), a Real-Time RAN Intelligent Controller (RT-RIC), a gNodeB (gNB), eNodeB (eNB), en-gNB, next generation eNB (ng-eNB), gNB-Central Unit (CU), gNB-CU-Control Plane (CP), gNB-CU-User Plane (UP), eNB-CU, eNB-CU-CP, eNB-CU-UP, Integrated Access and Backhaul (IAB)-node, IAB-donor DU, IAB-donor-CU, IAB-DU, IAB-Mobile Termination (MT), Open RAN (O)-CU, O-CU-CP, O-CU-UP, O-DU, O-Radio Unit (RU), O-eNB, an Artificial Intelligence (AI)/Machine Learning (ML) server.
The terms model training, model optimizing, model optimization, model updating are herein used interchangeably with the same meaning unless explicitly specified otherwise.
The terms model changing, modifying, or similar are herein used interchangeably with the same meaning unless explicitly specified otherwise. In particular, they refer to the fact that the type, structure, parameters, connectivity of an AI/ML model may have changed compared to a previous format/configuration of the AI/ML model.
The terms AI/ML model, AI/ML policy, AI/ML algorithm, as well as the terms, model, policy, or algorithm are herein used interchangeably with the same meaning unless explicitly specified otherwise.
References to “network nodes” herein should be understood such that a network node may be a physical node or a function or logical entity of any kind, e.g., a software entity implemented in a data center or a cloud, e.g., using one or more virtual machines, and two network nodes may well be implemented as logical software entities in the same data center or cloud.
The terms action type, action type identifier, action type ID, or types of action are used interchangeably with the same meaning, i.e., an indication of an action type
The terms action instance, specific action instance, action instance identifier, action instance ID, action ID are used interchangeably with the same meaning, i.e., an indication of an instance of a specific action.
The terms “AI/ML”, “AIML”, “MLAI”, “ML/AI” can be used interchangeably in the present disclosure.

Embodiments of the system and methods described herein are independent with respect to specific AI/ML model types or learning problems/setting (e.g., supervised learning, unsupervised learning, reinforcement learning, hybrid learning, centralized learning, federated learning, distributed learning, . . . ). Non-limiting examples of AI/ML algorithms may include supervised learning algorithms, deep learning algorithms, reinforcement learning types of algorithms (such as Deep Q-Network (DQN), Advantage Actor Critic (A2C), Asynchronous Advantage Actor Critic (A3C), etc.), contextual multi-armed bandit algorithms, autoregression algorithms, etc., or combinations thereof. Such algorithms may exploit functional approximation models, hereafter referred to as AI/ML models, such as neural networks (e.g., feedforward neural networks, deep neural networks, recurrent neural networks, convolutional neural networks, etc.). Examples of reinforcement learning algorithms may include deep reinforcement learning (such as DQN, proximal policy optimization (PPO), double Q-learning), actor-critic algorithms (such as Advantage actor-critic algorithms, e.g. A2C or A3C, actor-critic with experience replay, etc.), policy gradient algorithms, off-policy learning algorithms, etc.

Before describing embodiments of the present disclosure in detail, a discussion of a number of challenges with existing technology is beneficial. Some general agreements have been achieved on how to support AI/ML in a 3^{rd} Generation Partnership Project (3GPP) RAN. For example, it is agreed that AI/ML capability exchange in NG-RAN can be achieved by means of procedures for AI/ML information request, AI/ML information response, and AI/ML Information Request Failure. Also, as part of the ongoing discussions within the scope of the RAN1 Study Item (SI) on AI/ML mentioned above, different use cases have been agreed such as: Channel State Information (CSI) feedback enhancement, Beam management, and Positioning accuracy enhancements. Also, different aspects of Life Cycle Management (LCM) for the AI/ML models to be used, with various levels of interactions between a UE and a gNB in to support the above use cases, when the AI/ML model are deployed only at the UE, or only at the RAN, or at both sides. However, it is unclear how to make an efficient use of UE related AI/ML capabilities in the RAN.

Systems and methods that provide a solution(s) to the above-referenced and/or other challenges are disclosed herein. In this disclosure, the term “UE-associated types of available AI/ML assistance information” refers to indications indicating that the UE is able to support one or more of the options listed in the subsection below entitled “UE-Associated Types of Available AI/ML Assisting Information”.

Embodiments of the systems and methods described herein pertain to, e.g., any one or more of the following:
AI/ML model deployed (or to be deployed) only at network node(s), for which the UE can provide assistance information,
AI/ML model deployed (or to be deployed) only at UE(s), for which the network node or the UE can provide assistance information,
AI/ML model deployed (or to be deployed) both at network node(s) and at the UE, for which the UE can provide assistance information, or the network node can provide assistance information, or both

The UE-associated types of available AI/ML assistance information a UE can provide to a network node can be static, semi-static, or dynamic. For instance, a UE with certain AI/ML capabilities (related to Access Stratum, or to Non-Access Stratum, or to application layer):
can always indicate the same UE-associated types of available AI/ML assistance information, or
can indicate different UE-associated types of available AI/ML assistance information based on a combination of conditions, such as, e.g., the Radio Resource Control (RRC) state it is in, the estimated memory and/or computational power to support a network node with certain assistance information, the battery status, the estimated battery consumption.

Some variants of the proposed solution are described below. These variants can be used alone or in combination. While these variants are described below in more detail, they include the following:
Variant 1: A UE sends to a first network node UE-associated types of available AI/ML assistance information that the UE can provide to the first network node (or to a second network node via the first network node) to assist an AI/ML model.
Variant 2: A UE sends to a first network node an indication that the UE can provide UE-associated types of available AI/ML assistance information to the first network node (or to a second network node via the first network node) to assist an AI/ML model; the UE is subsequently requested to provide such information and sends it to the first network node (or to a second network node via the first network node).
Variant 3: A first network node requests to a UE to send UE-associated types of available AI/ML assistance information that the UE can provide to the first network node (or to a second network node via the first network node) to assist an AI/ML model.
Variant 4: A first network node sends to a second network node UE-associated types of available AI/ML assistance information that a UE can provide to the second network node (or to a third network node via the second network node) to assist an AI/ML model. This variant can apply to a mobility procedure, to a procedure to retrieve a UE context, or to a multi-connectivity related procedure.
Variant 5: A first network node sends to a second network node (or to a third network node via the second network node) an indication that a UE can provide UE-associated types of available AI/ML assistance information to the second network node (or to a third network node via the second network node) to assist an AI/ML model. This variant can apply to a mobility procedure, to a procedure to retrieve a UE context, or to a multi-connectivity related procedure.
   A request for UE-associated types of available AI/ML assistance information is sent from the second network node to the first network node.
Variant 6: A first network node sends to a second network node (or to a third network node via the second network node) an indication that a UE can provide UE-associated types of available AI/ML assistance information to the second network node (or to a third network node via the second network node) to assist an AI/ML model. This variant can apply to a mobility procedure, to a procedure to retrieve a UE context, or to a multi-connectivity related procedure. A request for UE-associated types of available AI/ML assistance information is sent from the second network node to the UE.
Variant 7: A first network node initiates the preparation of a conditional mobility procedure (e.g., a Conditional Handover), or initiates the preparation of a conditional multi-connectivity procedure (e.g., a Conditional Primary Secondary Cell (PSCell) Change, a Conditional PSCell Addition), and sends to a second network node (being one of the candidate nodes for one of the above procedures) an indication that a UE can provide UE-associated types of available AI/ML assistance information to the second network node (or to a third network node via the second network node) to assist an AI/ML model.
Variant 8: A first network node initiates the preparation of a conditional mobility procedure (e.g., a Conditional Handover), or initiates the preparation of a conditional multi-connectivity procedure (e.g., a Conditional PSCell Change, a Conditional PSCell Addition), and sends to a second network node (being one of the candidate nodes for one of the above procedures) an indication that a UE can provide UE-associated types of available AI/ML assistance information to the second network node (or to a third network node via the second network node) to assist an AI/ML model. The second network node stores the indication that the UE can provide UE-associated types of available AI/ML assistance information to the second network node (or to a third network node via the second network node) and sends the request for such information only after completion of the conditional mobility procedure (or conditional multi-connectivity procedure).

In one possible example of variants 1-8, the first network node may be a RAN node and the second network node may be a node outside the RAN, such as a core network node or an AI/ML server residing outside the radio access network.

In one possible example of variants 5-8, the first and the second network nodes are RAN nodes, whereas the third network node is not a RAN node, such as a core network node or an AI/ML server residing outside the radio access network.

In one embodiment, a method is provided for a UE to indicate to one or more network nodes the availability of AI/ML assistance information that the UE can provide as well as to indicate what UE-associated types of AI/ML assistance information the UE can provide to network nodes. The UE-associated types of UE available AI/ML assistance information that a user device can provide to a network node may be associated to AI/ML algorithms and or AI/ML models deployed and executed either by the user device itself or by the network nodes. In addition, the UE-associated types of UE available AI/ML assistance information that the user device can provide may be associated to one or more specific operations of the user device itself or of the network node, such as mobility related operation, energy savings related operations, load balance related operations, channel state information estimation operations, beam management operations, positioning operations, etc.

Embodiments of the present disclosure may provide a number of advantages. For example, embodiments of the present disclosure may reduce the signaling overhead between a user device and network node to configure an exchange of AI/ML assistance information. By informing the network node of the availability and/or the type and format of UE available AI/ML assistance information that the user device can provide, the exchange of such information between the user device and the network node can be optimized. For instance, the network node may efficiently request the correct AI/ML assistance information and in the right format as available from the user device, thereby reducing signaling overhead for erroneous requests for information that the user device may not provide.

In one possible variation, at least one of the UE-associated types of available AI/ML assistance information referenced herein pertains to the Access Stratum.

In another possible variation, at least one of the types of available AI/ML assistance information referenced herein pertains to the Non Access Stratum.

In yet another possible variation, at least one of the types of available AI/ML assistance information referenced herein pertains to the Application Layer.

### Variant 1

Variant 1: A UE sends to a first network node UE-associated types of available AI/ML assistance information that the UE can provide to the first network node (or to a second network node via the first network node) to assist an AI/ML model.

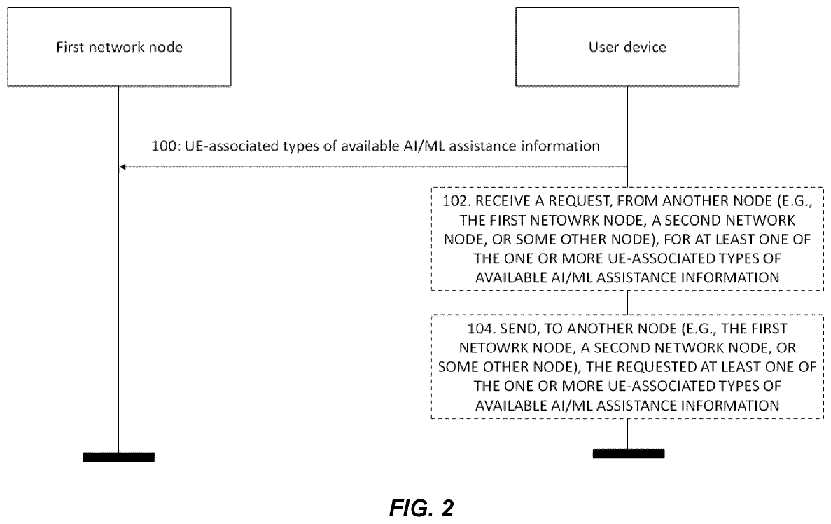

In this variant, illustrated in FIG. 2, the following steps are executed:
Step 100: A UE sends to a first network node (or to a second network node via a first network node) types of available AI/ML assistance information the UE can provide to a network node to assist an AI/ML model deployed (or to be deployed) at the network node.
   For instance, a UE adds types of available AI/ML assistance information it can offer to the network in one or more of the following RRC messages: an RRCResumeComplete message, an RRCSetupComplete message, an RRCReconfigurationComplete message, an RRCReestablishmentComplete message, an UECapabilityInformation message, an ULInformationTransfer message, an UEInformationResponse message, an UEAssistanceInformation message, a MeasurementReport message, an ULInformationTransferMRDC message
Step 102 (Optional): The UE receives, from another node, a request for at least one of the UE-associated type of available AI/ML assistance information (indicated in step 100). The node from which the request is received may be, e.g., the first network node, another network node (e.g., a second network node), or some other node.
Step 104 (Optional): In response to the request, the UE sends the requested at least one of the UE-associated types of available AI/ML assistance information to the other node. In other words, the UE sends, to the other node, AI/ML assistance information of the requested type(s).

### Variant 2

Variant 2: A UE sends to a first network node indication that the UE can provide UE-associated types of available AI/ML assistance information to the first network node (or to a second network node via the first network node) to assist an AI/ML model; the UE is subsequently requested to provide such information and sends it to the first network node (or to a second network node via the first network node).

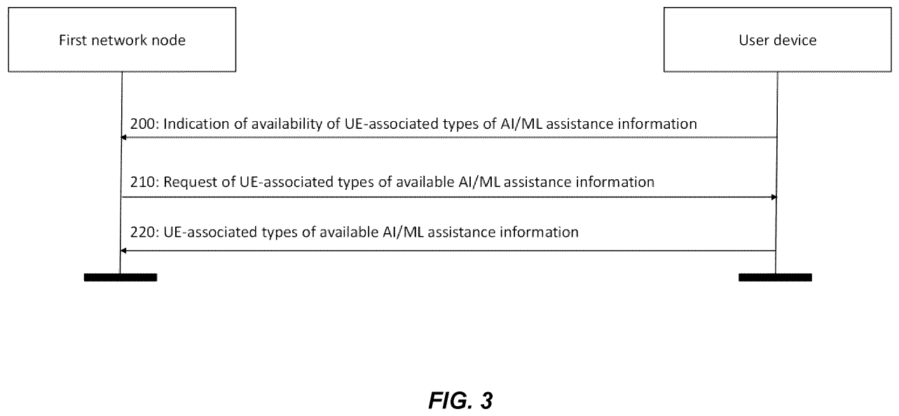

In this variant, illustrated in FIG. 3, the following steps are executed:
Step 200: a UE sends to the first network node (or to a second network node via the first network node) indication(s) that the UE can provide to the first network node (or to the second network node via the first network node) a set of at least one types of available AI/ML assistance information to assist an AI/ML model.
   Step 200 can be implemented by means of a new Information Element added to an existing Uplink message comprised in at least one of the RRC Connection Establishment procedure, the RRC Connection Resume procedure, the RRC Connection Re-establishment procedure.
   For instance, a UE adds a new flag which—if set to 1—indicates that it has types of available AI/ML assistance information to offer to the network. The new flag can be included in one or more of the following RRC messages: an RRCResumeComplete message, an RRCResumeRequest/RRCResumeRequest1 message, an RRCSetupComplete message, an RRCSetupRequest message, an RRCReconfigurationComplete message, an RRCReestablishmentComplete message, an UECapabilityInformation message, an ULInformationTransfer message, an UEInformationResponse message, an UEAssistanceInformation message, a MeasurementReport message, a MeasurementReportAppLayer message, an ULInformationTransferMRDC message
Step 210: the first network node requests to the UE to provide types of available AI/ML assistance information (i.e., types of UE associated available AI/ML assistance information) that can be used to assist an AI/ML model.
   Step 210 can be implemented by means of a new Information Element added to an existing Downlink message comprised in at least one of the RRC Reconfiguration procedure, RRC Transfer procedure, RRC Connection Establishment procedure, RRC Connection Resume procedure, RRC Connection Re-establishment procedure.
   According to embodiments, first network node requests may include a single bit of information (e.g., referred to as types of UE associated available AI/ML assistance information) which may, e.g., be set to a specific value (e.g., 1 or 0).
      According to other embodiments, if only the types of UE associated available AI/ML assistance information bit is set to 1, this implies a request to receive assistance information for all available types of predictions and associated formats (e.g., the reference prediction time and/or reliability conditions).
      According to yet other embodiments, if the types of UE associated available AI/ML assistance information bit is set to 1, and at least another specific prediction type is also requested, this implies a request to receive assistance information only for the indicated types of predictions.
Step 220: same as step 100 described in Variant 1

### Variant 3

Variant 3: A first network node requests to a UE to send UE-associated types of available AI/ML assistance information that the UE can provide to the first network node (or to a second network node via the first network node) to assist an AI/ML model.

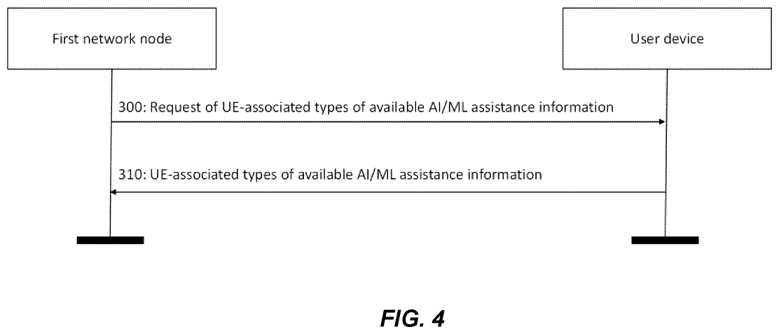

In this variant, illustrated in FIG. 4, the following steps are executed:
Step 300: same as step 210 described in Variant 2
Step 310: same as step 100 described in Variant 1

### Variant 4

Variant 4: a first network node sends to a second network node UE-associated types of available AI/ML assistance information that a UE can provide to the second network node (or to a third network node via the second network node) to assist an AI/ML model. This variant can apply to a mobility procedure, to a procedure to retrieve a UE context, or to a multi-connectivity related procedure.

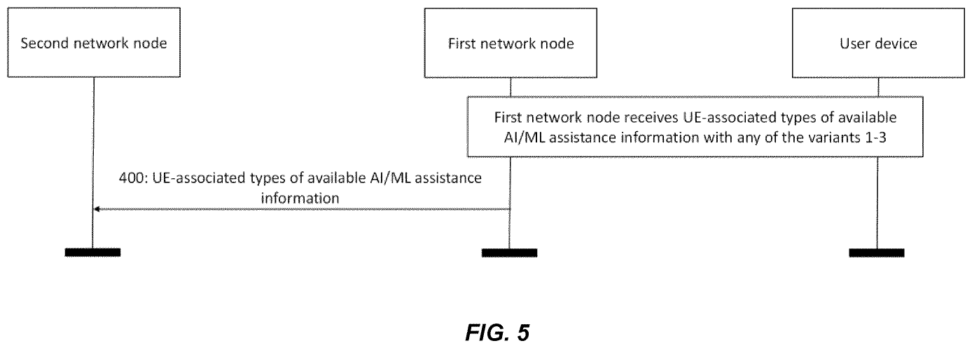

In one example of this variant, illustrated in FIG. 5, the first network node may receive the UE-associated types of available AI/ML assistance information from the user device with any of the signaling described in variants 1-3 prior to forwarding such information to the second network node.

In this variant, the following steps are executed:
Step 400: A first network node sends to a second network node (or to a third network node via the second network node) UE-associated types of available AI/ML assistance information that a UE can provide to the second network node to assist an AI/ML model. The sending can be part of a mobility procedure, or as part of a procedure to retrieve a UE context, or as part of a multi-connectivity procedure.
   (Case 1: Handover, new IE) In one case, related to mobility, this step is executed during the preparation phase of a handover (e.g., as part of the Handover Preparation XnAP procedure) and UE-associated types of available AI/ML assistance information is included as a new Information Element (e.g., an “UEAS AI/ML Information” IE) in a message used for the handover preparation (e.g., is included in a HANDOVER REQUEST XnAP message).
   (Case 2: Handover, modification of existing IE) In one case, related to mobility, this step is executed during the preparation phase of a handover (e.g., as part of the Handover Preparation XnAP procedure) and UE-associated types of available AI/ML assistance information is included in an existing Information Element comprised in a message used for the handover preparation (e.g., is included in a HANDOVER REQUEST XnAP message). The content of the existing IE is updated to comprise UE-associated types of available AI/ML assistance information for a UE. One example of such existing IE is the RRC Context IE, of type OCTET STRING included in the HANDOVER REQUEST XnAP message, which includes the HandoverPreparationInformation message as defined in subclause 11.2.2 of TS 38.331 v17.3.0 when the target NG-RAN node is a gNB. In this example, the HandoverPreparationInformation is extended to include UE-associated types of available AI/ML assistance information for the UE subject to handover.
   (Case 3: UE Context retrieval, new IE) In one case, related to mobility, this step is executed during the retrieval of the UE context from another network node (e.g., as part of the Retrieve UE Context XnAP procedure), and UE-associated types of available AI/ML assistance information is included as a new Information Element (e.g., an “UE ASAI/ML Information” IE) in a message used for UE Context retrieval (e.g., is included in a RETRIEVE UE CONTEXT RESPONSE XnAP message, as a sub-IE of the UE Context Information-Retrieve UE Context Response IE).
   (Case 4: UE Context retrieval, modification of existing IE) In one case, related to mobility, this step is executed during the retrieval of the UE context from another network node (e.g. as part of the Retrieve UE Context XnAP procedure), and UE-associated types of available AI/ML assistance information is included as an existing Information Element comprised in a message used for the UE Context retrieval (e.g., is included in a RETRIEVE UE CONTEXT RESPONSE XnAP message). The content of the existing IE is updated to comprise UE-associated types of available AI/ML assistance information for a UE. One example of such existing IE is the RRC Content IE within the UE Context Information-Retrieve UE Context Response IE, of type OCTET STRING included in the HANDOVER REQUEST XnAP message, which includes the HandoverPreparationInformation message as defined in subclause 11.2.2 of TS 38.331 if the old and new serving NG-RAN nodes are gNB. In this example, the HandoverPreparationInformation is extended to include UE-associated types of available AI/ML assistance information for the UE subject to handover.
   (Case 5: Multi-connectivity, new IE) In one case, this step is executed during the preparation phase of a multi-connectivity procedure, for instance when adding a Secondary Node (as part of an S-NG-RAN node Addition Preparation XnAP procedure), or when changing the Secondary Node (as part of an S-NG-RAN node initiated S-NG-RAN node Change XnAP procedure), and similarly to the case of handover, the UE-associated types of available AI/ML assistance information for a UE is included as a new Information Element (e.g., an “UE AS AI/ML Information” IE) comprised in a message used for the multi-connectivity procedure (e.g., is included in a S-NODE ADDITION REQUEST XnAP message).
   (Case 6: Multi-connectivity, modification of existing IE) In one case, related to multi-connectivity, this step is executed during the preparation phase of the multi-connectivity (e.g., as part of an S-NG-RAN node Addition Preparation XnAP procedure) and UE-associated types of available AI/ML assistance information is included as an existing Information Element comprised in a message used for the multi-connectivity (e.g., is included in a S-NODE ADDITION REQUEST XnAP message). The content of the existing IE is updated to comprise UE-associated types of available AI/ML assistance information for a UE. One example of such existing IE is the M-NG-RAN node to S-NG-RAN node Container IE, of type OCTET STRING included in the HANDOVER REQUEST XnAP message, which includes the CG-ConfigInfo message as defined in subclause 11.2.2 of TS 38.331. In this example, the CG-ConfigInfo is extended to include UE-associated types of available AI/ML assistance information for the UE subject to handover.

### Variant 5

Variant 5: a first network node sends to a second network node (or to a third network node via the second network node) an indication that a UE can provide UE-associated types of available AI/ML assistance information to the second network node (or to a third network node via the second network node) to assist an AI/ML model. This variant can apply to a mobility procedure, to a procedure to retrieve a UE context, or to a multi-connectivity related procedure.

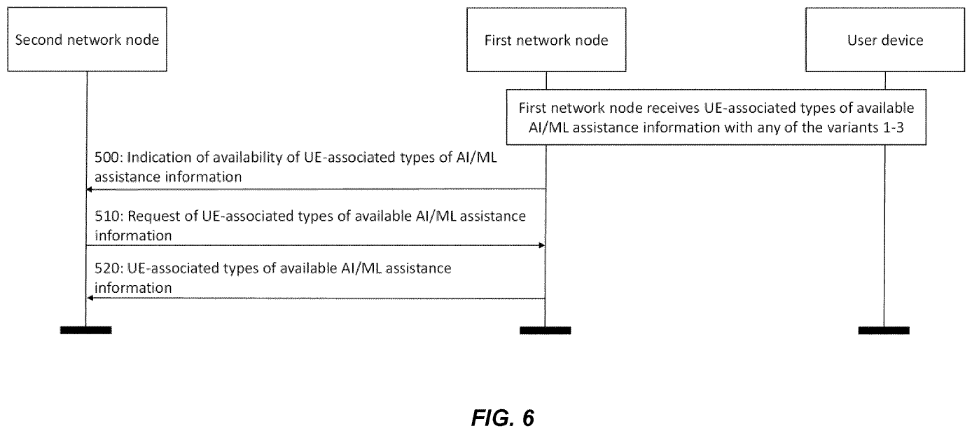

In one example of this variant, illustrated in FIG. 6, the first network node may receive the UE-associated types of available AI/ML assistance information from the user device with any of the signaling described in variants 1-3 prior to forwarding such information to the second network node.

In this variant, the following steps are executed:
Step 500: A first network node sends to a second network node (or to a third network node via the second network node) an indication that a UE can provide UE-associated types of available AI/ML assistance information to the second network node (or to a third network node via the second network node) to assist an AI/ML model. The sending can be part of a mobility procedure, or as part of a procedure to retrieve a UE context, or as part of a multi-connectivity procedure.
   This step can be realized in a similar way as step 400 in previous variant, where the first network node, using a new IE or a modified IE, sends to the second network node an indication that the UE can provide UE-associated types of available AI/ML assistance information (instead of sending UE-associated types of available AI/ML assistance information)
Step 510: The second network node sends a request to the first network node to provide the UE-associated types of available AI/ML information. This step could also be realized, for instance, as part a mobility procedure, or the procedure to retrieve a UE context, or the multi-connectivity procedure is completed as in legacy.
   For the mobility procedure, the UE is the subject of a handover request to the second network node (the target node) while still being served by the first network node (the source node). The second network node, as part of handover acknowledgement message may then request the first network node to provide the UE-associated types of available AI/ML assistance information.
   For the case of retrieval of UE context, the UE is served by the second network node
   For the case of multi-connectivity procedure, the UE established a connection towards the second network node
Step 520: the first network node provides UE-associated types of available AI/ML assistance information to the second network node
   step 520 could be a new signal of a handover procedure, where after the target network node acknowledges the handover for a user device, the first network node provides additional information to the second network node related to UE-associated types of available AI/ML assistance information
   step 520 could also be a signal of a different procedure compared to steps 500 and 510. For instance, steps 500-510 could be realized by signals of a handover preparation, i.e., handover request and handover acknowledge, respectively, whereas step 520 could be realized by means of an SN status transfer or early status transfer message.

In case of multi-connectivity, the step can be executed directly from the second network node towards the UE or via the first network node (in the latter case, e.g., the request can be sent from the SN node to the MN node, and the MN node sends the SN node).

### Variant 6

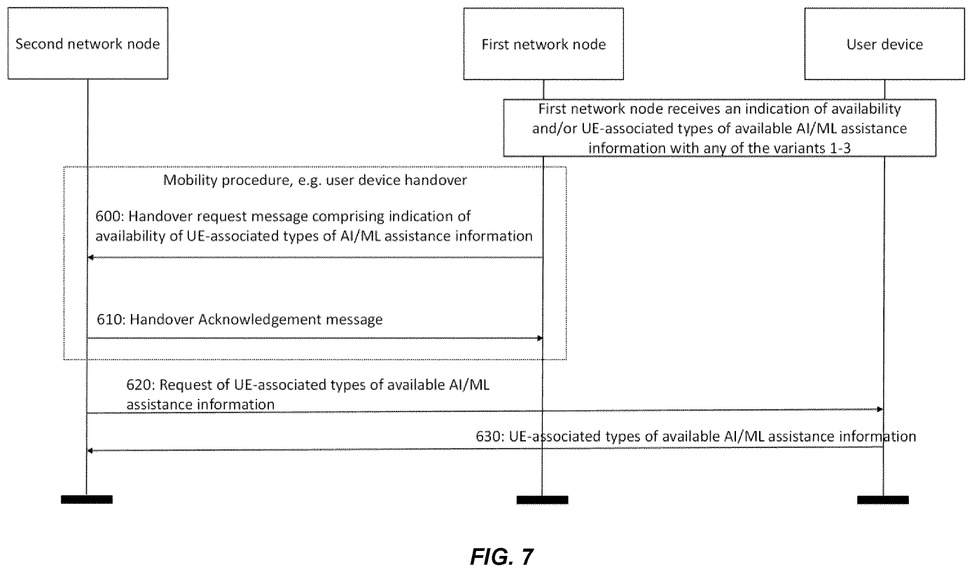

Variant 6: a first network node sends to a second network node (or to a third network node via the second network node) an indication that a UE can provide UE-associated types of available AI/ML assistance information to the second network node (or to a third network node via the second network node) to assist an AI/ML model. This variant can apply to a mobility procedure, to a procedure to retrieve a UE context, or to a multi-connectivity related procedure. An example of this variant is illustrated in FIG. 7, where signaling from a mobility procedure, such as handover are partly reused to indicate to the second network node (e.g., the target node of a mobility handover) the availability of UE AI/ML assistance information for the user device that is being handed over to the second network node.

In this variant, the following steps are executed:
Step 600: A first network node sends to a second network node (or to a third network node via the second network node) an indication that a UE can provide UE-associated types of available AI/ML assistance information to the second network node (or to a third network node via the second network node) to assist an AI/ML model. The sending can be part of a mobility procedure, or as part of a procedure to retrieve a UE context, or as part of a multi-connectivity procedure.
   This step can be realized in a similar way as step 400 in previous variant, where the first network node, using a new IE or a modified IE, sends to the second network node an indication that the UE can provide UE-associated types of available AI/ML assistance information (instead of sending UE-associated types of available AI/ML assistance information)
Step 610: The mobility procedure, or the procedure to retrieve a UE context, or the multi-connectivity procedure is completed as in legacy.
   For the mobility procedure, the UE is served by the second network node (target network node)
   For the case of retrieval of UE context, the UE is served by the second network node
   For the case of multi-connectivity procedure, the UE established a connection towards the second network node
Step 620: the second network node requests the UE to provide UE-associated types of available AI/ML assistance information.
   Step 620 is executed between the second network node and the UE.
In case of multi-connectivity, the step can be executed directly from the second network node towards the UE or via the first network node (in the latter case, e.g., the request can be sent from the SN node to the MN node, and the MN node sends the SN node request to the UE using a DRB/SRB established between the UE and the MN node)
Step 630: the UE sends to the second network node UE-associated types of available AI/ML assistance information.
   Step 630 is executed between the UE and the second network node
      In case of multi-connectivity, the step can be executed directly from the UE towards the second network node or via the first network node (in the latter case, e.g., the UE can send the response to the MN node, using a DRB/SRB established between the UE and the MN node, and the MN node forwards the UE response to the SN node)

### Variant 7

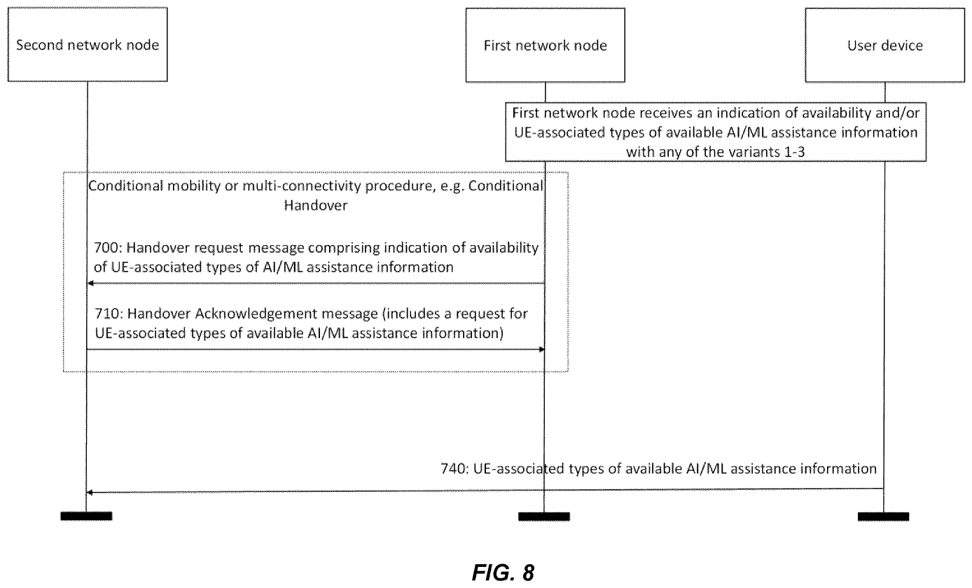

Variant 7: a first network node initiates the preparation of a conditional mobility procedure (e.g., a Conditional Handover), or initiates the preparation of a conditional multi-connectivity procedure (e.g., a Conditional PSCell Change, a Conditional PSCell Addition), and sends to a second network node (being one of the candidate nodes for one of the above procedures) an indication that a UE can provide UE-associated types of available AI/ML assistance information to the second network node (or to a third network node via the second network node) to assist an AI/ML model. An example of this variant is illustrated in FIG. 8, where signaling from a mobility procedure, such as handover are partly reused to indicate to the second network node (e.g., the target node of a mobility handover) the availability of UE AI/ML assistance information for the user device that is being handed over to the second network node.

In this variant, the following steps are executed:
Step 700: A first network node sends to a second network node an indication that a UE can provide UE-associated types of available AI/ML assistance information to the second network node to assist an AI/ML model. The sending can be part of a conditional mobility procedure, or as part of a conditional multi-connectivity procedure.
   This step can be realized in a similar way as step 400 in previous variant, where the first network node, using a new IE or a modified IE, sends to the second network node an indication that the UE can provide UE-associated types of available AI/ML assistance information (instead of sending UE-associated types of available AI/ML assistance information)
Step 710: the second network node sends a message (e.g., a HANDOVER ACKNOWLEDGE XnAP message) with an RRC Reconfiguration for the UE that includes a request to provide UE-associated types of available AI/ML assistance information to the second network node upon completion of the conditional mobility procedure.
Step 720: the first network node sends an RRC Reconfiguration comprising the second network node prepared RRC Reconfiguration including the request for the UE to provide UE-associated types of available AI/ML assistance information to the second network node
Step 730: The conditional mobility procedure, or the conditional multi-connectivity procedure is completed as in legacy.
   For the conditional mobility procedure, the UE is served only by the second network node (target network node)
   For the case of conditional multi-connectivity procedure, the UE established a connection towards the second network node
Step 740: the UE sends to the second network node UE-associated types of available AI/ML assistance information.
   Step 740 is executed between the UE and the second network node
      In case of multi-connectivity, the step can be executed directly from the UE towards the second network node or via the first network node (in the latter case, e.g., the UE can send the response to the MN node, using a DRB/SRB established between the UE and the MN node, and the MN node forwards the UE response to the SN node)

### Variant 8

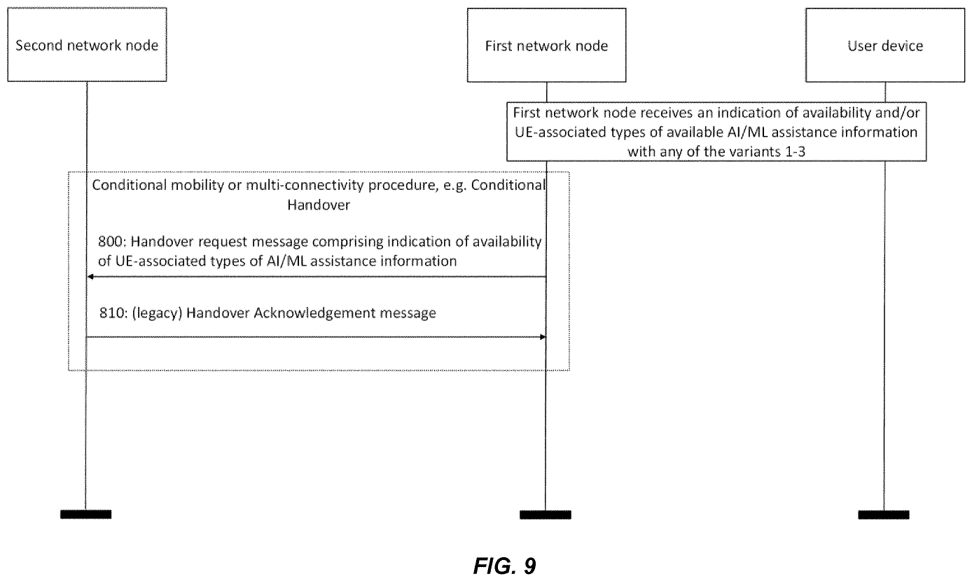

Variant 8: a first network node initiates the preparation of a conditional mobility procedure (e.g., a Conditional Handover), or initiates the preparation of a conditional multi-connectivity procedure (e.g., a Conditional PSCell Change, a Conditional PSCell Addition), and sends to a second network node (being one of the candidate nodes for one of the above procedures) an indication that a UE can provide UE-associated types of available AI/ML assistance information to the second network node (or to a third network node via the second network node) to assist an AI/ML model. The second network node stores the indication that the UE can provide UE-associated types of available AI/ML assistance information to the second network node (or to a third network node via the second network node) and sends the request for such information only after completion of the conditional mobility procedure (or conditional multi-connectivity procedure). An example of this variant is illustrated in FIG. 9.

In this variant, the following steps are executed:
Step 800: A first network node sends to a second network node an indication that a UE can provide UE-associated types of available AI/ML assistance information to the second network node (or the third network node via the second network node) to assist an AI/ML model. The sending can be part of a conditional mobility procedure, or as part of a conditional multi-connectivity procedure.
   This step can be realized in a similar way as step 400 in previous variant, where the first network node, using a new IE or a modified IE, sends to the second network node an indication that the UE can provide UE-associated types of available AI/ML assistance information (instead of sending UE-associated types of available AI/ML assistance information)
Step 810: the second network node sends a message (e.g., a HANDOVER ACKNOWLEDGE XnAP message)
Step 820: The conditional mobility procedure, or the conditional multi-connectivity procedure is completed as in legacy.
   For the conditional mobility procedure, the UE is served only by the second network node (target network node)
   For the case of conditional multi-connectivity procedure, the UE established a connection towards the second network node
Step 830: the second network node requests to the UE to provide UE-associated types of available AI/ML assistance information.
   Step 830 is executed between the UE and the second network node
      In case of single connectivity, the step can be executed as described in Variant 1 or in Variant 3
      In case of multi-connectivity, the step can be executed as described in Variant 1 or in Variant 3 directly from the UE towards the second network node or via the first network node (in the latter case, e.g., the UE can send the response to the MN node, using a DRB/SRB established between the UE and the MN node, and the MN node forwards the UE response to the SN node)

### UE-Associated Types of Available AI/ML Assisting Information

UE-associated types of available AI/ML assisting information refers to indications indicating that the UE is able to support one or more of the following:
support to provide certain predictions (e.g., support to provide UE performance, support to predict the trigger of a certain mobility related event), which may include one or more of:
   type of information for which predictions are supported,
   reference prediction time for which predictions can be supported, wherein the reference prediction time indicates a time in the future for which prediction of certain information can be determined,
      according to one embodiment; for a given type of information, predictions may be supported based on one or more reference prediction time,
      according to one embodiment; reference prediction time may be indicated as a time offset from the time when a prediction is determined,
   AI/ML model prediction quality or performance associated to different type of information for which predictions can be provided and/or different type of supported reference prediction time,
      according to one embodiment; AI/ML model prediction quality or performance may be expressed as AI/ML model prediction accuracy, or AI/ML model prediction error, such as a mean squared error,
         Thereby, predictions of different type of information and/or associated to different reference prediction time may be available or supported with different AI/ML model prediction quality.
   one or more type of supported events or conditions that can be configured to trigger predictions. In addition, specific supported configurations for triggering events or conditions may be indicated, such as threshold values associated to specific parameters or measurements.
   reliability conditions associated predictions, i.e., conditions on the basis of which the provided predictions for a reference prediction time are reliable (or trustworthy, i.e., can be used), or are not reliable.
      according to one embodiment; reliability conditions may be associated to one or more of:
         information type for which predictions are supported,
         reference prediction time for which predictions are supported, or
         a combination thereof,
   in some non-limiting examples, reliability conditions can pertain to at least one RRC state, to a DRX (Discontinuous Reception) or a DTX (Discontinuous Transmission) configuration, to energy (or power) related information (such as an energy state, an energy index, a power state, an power index), to the use of certain service or service types, to performing QoE (Quality of Experience) measurements (with further granularity on certain service types for which QoE measurements are performed), to the delivery of certain type of traffic (e.g., bursty traffic, periodic traffic, delay critical traffic), to a certain mobility state, to a certain value or range of values of UE speed,
provide training data for the AI/ML model,
train or re-train the AI/ML model,
validate (or participate in validating) the AI/ML model,
authenticate (or participate in authenticating) the AI/ML model,
participate in executing the AI/ML model,
support (up to) a certain number of hidden layers in neural network AI/ML models,
support to provide a certain number (e.g., a maximum number) of hidden units/nodes per hidden layer of the for a certain type of AI/ML model,
support specific types of AI/ML models (e.g., feed-forward neural networks, convolutional neural networks, recurrent neural networks, graph neural networks, attention models, autoencoders, etc.),
support specific types of AI/ML algorithms (e.g., supervised learning, unsupervised learning, reinforcement learning, federated learning, etc.),
support certain AI/ML use cases or AI/ML based network operations,
support for joint AI/ML operation between UE and a network node,
support for certain collaboration levels between a UE and a network node. This can refer, e.g., to the support certain LCM operations when an AI/ML model deployed partly at the UE and partly at a network node. It can also refer to the fact that delivery of an AI/ML model is transparent to 3GPP signaling over the air interface or not,
support for certain training strategy(ies),
support for partial AI/ML model training at UE side/network side,
support to infer certain information,
support to use certain inferred information,
support for periodic/aperiodic feedback assistance information (e.g., for AI/ML model monitoring),
support for testing Life Cycle Management (LCM),
support for LCM procedures such as: activation/deactivation of AI/ML model, switching between AI/ML models, fallback to one AI/ML model, registration of an AI/ML model, updates of an AI/ML model,
support for operations/procedures/functionalities related to AI/ML at UE Access Stratum,
support for operations/procedures/functionalities related to AI/ML at UE Non-Access Stratum,
support for operations/procedures/functionalities related to AI/ML at UE Application layer,
support to provide feedback for an action triggered/recommended by an AI/ML model,
support to provide positioning labels in relation to AI/ML data samples,
support to provide timestamps labels in relation to AI/ML data samples.

A UE can indicate to conditions based on which it can assist the AI/ML model, such as:
while executing (or not executing) certain radio procedures (e.g., while performing mobility)
while being configured for and/or collecting certain radio measurements
while being configured for and/or determining certain predicted radio measurements
while configured for and/or collecting application layer measurements
a minimum (or average) available storage capacity
a minimum (or average) available computational/hardware capability
a minimum available battery level
when in certain mobility state
when moving within/above a certain speed
when at least one MDT related measurement is ongoing
when location/positioning measurements are available/enabled
when high precision positioning measurements are available/enabled
when UE-based and/or UE-assisted positioning is available/enabled
when sensor measurements are available/enabled

A UE can send to a network node to a network node (possibly updated) types of available AI/ML assistance information according to one or more of the above conditions. For example, a UE can send a first types of available AI/ML assistance information when one of more of its battery level/storage capacity is above a threshold X, and sends an updated types of available AI/ML assistance information when one of more of its battery level/storage capacity is below a threshold Y.

A UE can indicate to a network node that previously communicated UE-associated types of available AI/ML assistance information are no longer valid, according to one or more of the above conditions.

### Examples of Implementation

In this section some examples of implementations are shown, where the parts marked in yellow and made bold, italic and underlined pertains to additions of the present disclosure.

In a first example of implementation of Variant 1, a UE sends to a RAN node one or more UE-associated types of available AI/ML assistance information by extending an RRCSetupComplete RRC message.

In a second example of implementation of Variant 2, a UE sends to a RAN node an indication indicating the possibility to send UE-associated types of available AI/ML assistance information.

Both the first and second examples are reported below and made visible in different sub-section

-- ASN1START
-- TAG-RRCSETUPCOMPLETE-START

| | |
|---|---|
| RRCSetupComplete ::= | SEQUENCE { |
| rrc-TransactionIdentifier | RRC-TransactionIdentifier, |
| criticalExtensions | CHOICE { |
| rrcSetupComplete | RRCSetupComplete-IEs, |

| | |
|---|---|
| criticalExtensionsFuture | SEQUENCE { } |

}
}

| RRCSetupComplete-IEs ::= | SEQUENCE { | |
|---|---|---|
| selectedPLMN-Identity | INTEGER (1..maxPLMN), | |
| registeredAMF | RegisteredAMF | OPTIONAL, |

| | | |
|---|---|---|
| guami-Type | ENUMERATED {native, mapped} | OPTIONAL, |

| | |
|---|---|
| s-NSSAI-List | SEQUENCE (SIZE (1..maxNrofS-NSSAI)) OF S-NSSAI OPTIONAL, |

| | |
|---|---|
| dedicatedNAS-Message | DedicatedNAS-Message, |

| | |
|---|---|
| ng-5G-S-TMSI-Value | CHOICE { |
| ng-5G-S-TMSI | NG-5G-S-TMSI, |

| | |
|---|---|
| ng-5G-S-TMSI-Part2 | BIT STRING (SIZE (9)) |

| | |
|---|---|
| } | OPTIONAL, |

| | | |
|---|---|---|
| lateNonCriticalExtension | OCTET STRING | OPTIONAL, |
| nonCriticalExtension | RRCSetupComplete-v1610-IEs | OPTIONAL |

}

| | |
|---|---|
| RRCSetupComplete-v1610-IEs ::= | SEQUENCE { |

| | | |
|---|---|---|
| iab-NodeIndication-r16 | ENUMERATED {true} | OPTIONAL, |
| idleMeasAvailable-r16 | ENUMERATED {true} | OPTIONAL, |

| | | |
|---|---|---|
| ue-MeasurementsAvailable-r16 | UE-MeasurementsAvailable-r16 | OPTIONAL, |

| | | |
|---|---|---|
| mobilityHistoryAvail-r16 | ENUMERATED {true} | OPTIONAL, |

| | | |
|---|---|---|
| mobilityState-r16 | ENUMERATED {normal, medium, high, spare} | OPTIONAL, |

| | | |
|---|---|---|
| nonCriticalExtension | RRCSetupComplete-v1690-IEs | OPTIONAL |

}

| RRCSetupComplete-v1690-IEs ::= | SEQUENCE { | |
|---|---|---|
| ul-RRC-Segmentation-r16 | ENUMERATED {true} | OPTIONAL, |

| | | |
|---|---|---|
| nonCriticalExtension | RRCSetupComplete-v1700-IEs | OPTIONAL |

}

| | |
|---|---|
| RRCSetupComplete-v1700-IEs ::= | SEQUENCE { |

| | | |
|---|---|---|
| onboardingRequest-r17 | ENUMERATED {true} | OPTIONAL, |
| nonCriticalExtension | SEQUENCE{ } | OPTIONAL |

```
}
[Example of implementaton according to Variant 1 - Start]
RRCSetupComplete-v1900-IEs ::= SEQUENCE {
  alMLAvailableAssistanceInfoType-r19 AlMLAvaialableAssistanceInfoType-r19 OPTIONAL,
  nonCriticalExtension SEQUENCE{ } OPTIONAL
}
AlMLAvailableAssistanceInfoType-r19::= SEQUENCE {
  uEPredictionsAvailable ENUMERATED {true}
    uEPredictionsOfMobilityEvents ENUMERATED {true}
  numberOfHiddenLayer INTEGER (1..maxHiddenLayer)
  nonCrititalExtension SEQUENCE{ }
}
[Example of implementaton according to Variant 1 - End]
[Example of implementaton according to Variant 2 - Start]
RRCSetupComplete-v1900-IEs ::= SEQUENCE {
  alMLAvailableAssistanceInfoTypeAvailable-r19 ENUMERATED {true} OPTIONAL,
  nonCriticalExtension SEQUENCE{ } OPTIONAL
}
[Example of implementaton according to Variant 2 - End]
```

| RegisteredAMF ::= | SEQUENCE { | |
|---|---|---|
| plmn-Identity | PLMN-Identity | OPTIONAL, |

| | |
|---|---|
| amf-Identifier | AMF-Identifier |

}
-- TAG-RRCSETUPCOMPLETE-STOP
-- ASN1STOP
In a third example of implementation, a UE sends to a RAN node UE-associated types of available AI/ML
assistance information by extending an UEInformationResponse RRC message.

| | |
|---|---|
| UEInformationResponse-r16 ::= | SEQUENCE { |

| | |
|---|---|
| rrc-TransactionIdentifier | RRC-TransactionIdentifier, |
| criticalExtensions | CHOICE { |

| | |
|---|---|
| ueInformationResponse-r16 | UEInformationResponse-r16-IEs, |

| | |
|---|---|
| criticalExtensionsFuture | SEQUENCE { } |

}
}

| UEInformationResponse-r16-IEs ::= | SEQUENCE { | |
|---|---|---|
| measResultIdleEUTRA-r16 | MeasResultIdleEUTRA-r16 | OPTIONAL, |

| | | |
|---|---|---|
| measResultIdleNR-r16 | MeasResultIdleNR-r16 | OPTIONAL, |

| | | |
|---|---|---|
| logMeasReport-r16 | LogMeasReport-r16 | OPTIONAL, |

| | | |
|---|---|---|
| connEstFailReport-r16 | ConnEstFailReport-r16 | OPTIONAL, |

| | | |
|---|---|---|
| ra-ReportList-r16 | RA-ReportList-r16 | OPTIONAL, |
| rlf-Report-r16 | RLF-Report-r16 | OPTIONAL, |

| | | |
|---|---|---|
| mobilityHistoryReport-r16 | MobilityHistoryReport-r16 | OPTIONAL, |
| lateNonCriticalExtension | OCTET STRING | OPTIONAL, |

| | | |
|---|---|---|
| nonCriticalExtension | UEInformationResponse-v1700-IEs | OPTIONAL |

}

| | |
|---|---|
| UEInformationResponse-v1700-IEs ::= | SEQUENCE { |

| | | |
|---|---|---|
| successHO-Report-r17 | SuccessHO-Report-r17 | OPTIONAL, |
| connEstFailReportList-r17 | ConnEstFailReportList-r17 | OPTIONAL, |

| | | |
|---|---|---|
| coarseLocationInfo-r17 | OCTET STRING | OPTIONAL, |

| | | |
|---|---|---|
| nonCriticalExtension | SEQUENCE { } | OPTIONAL |

```
}
(skip unchanged)
UEInformationResponse-v1900-IEs ::= SEQUENCE {
  alMLAvailableAssistanceInfoTypes-r19 AlMLAvailableAssistanceInfoTypes-r19
OPTIONAL,
  nonCriticalExtension SEQUENCE{ } OPTIONAL
}
AlMLAvailableAssistanceInfoTypes-r19::= SEQUENCE {
  uEPredictionsAvailable ENUMERATED {true}
    uEPredictionOfMobilityEvents ENUMERATED {true}
  numberOfHiddenLayer INTEGER (1..maxHiddenLayer)
  nonCriticalExtension SEQUENCE{ }
}
-- TAG-UEINFORMATIONRESPONSE-STOP
-- ASN1STOP
```

### Further Description

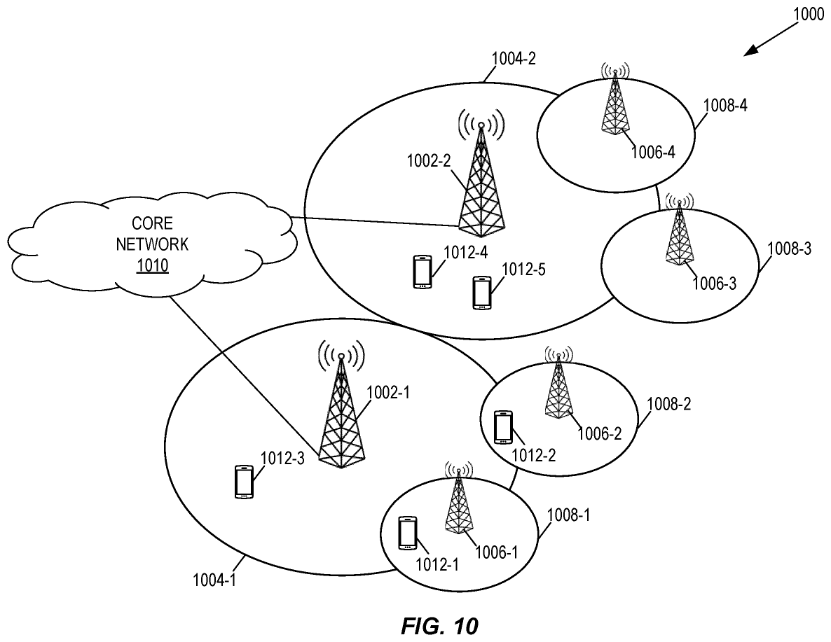

FIG. 10 illustrates one example of a cellular communications system 1000 in which embodiments of the present disclosure may be implemented. In the embodiments described herein, the cellular communications system 1000 is a 5G system (5GS) including a Next Generation RAN (NG-RAN) and a 5G Core (5GC); however, embodiments of the present disclosure may be implemented in other types of wireless communications systems such as, e.g., an EPS/LTE system, a 6^{th} Generation (6G) system, or the like. In this example, the RAN includes base stations 1002-1 and 1002-2, which in the 5GS include NR base stations (gNBs) and optionally next generation eNBs (ng-eNBs) (e.g., LTE RAN nodes connected to the 5GC), controlling corresponding (macro) cells 1004-1 and 1004-2.

The base stations 1002-1 and 1002-2 are generally referred to herein collectively as base stations 1002 and individually as base station 1002. Likewise, the (macro) cells 1004-1 and 1004-2 are generally referred to herein collectively as (macro) cells 1004 and individually as (macro) cell 1004. The RAN may also include a number of low power nodes 1006-1 through 1006-4 controlling corresponding small cells 1008-1 through 1008-4. The low power nodes 1006-1 through 1006-4 can be small base stations (such as pico or femto base stations) or RRHs, or the like. Notably, while not illustrated, one or more of the small cells 1008-1 through 1008-4 may alternatively be provided by the base stations 1002. The low power nodes 1006-1 through 1006-4 are generally referred to herein collectively as low power nodes 1006 and individually as low power node 1006. Likewise, the small cells 1008-1 through 1008-4 are generally referred to herein collectively as small cells 1008 and individually as small cell 1008. The cellular communications system 1000 also includes a core network 1010, which in the 5G System (5GS) is referred to as the 5GC. The base stations 1002 (and optionally the low power nodes 1006) are connected to the core network 1010.

The base stations 1002 and the low power nodes 1006 provide service to UEs 1012-1 through 1012-5 in the corresponding cells 1004 and 1008. The UEs 1012-1 through 1012-5 are generally referred to herein collectively as UEs 1012 and individually as UE 1012.

Note that the UEs 1012 may perform the functionality of the user device or UE described above, e.g., with respect to Variants 1-8. Further, in one embodiment, the base station 1002 is an example of the first network node described above, e.g., with respect to Variants 1-8. Still further, in one embodiment, the second network node described above, e.g., with respect to Variants 1-8, may be, e.g., another base station 1002 or a core network node.

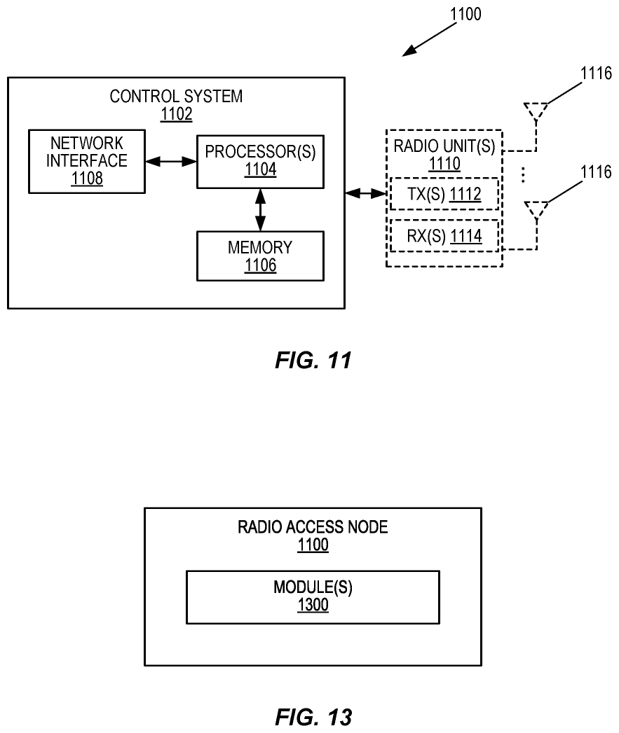

FIG. 11 is a schematic block diagram of a radio access node 1100 according to some embodiments of the present disclosure. Optional features are represented by dashed boxes. The radio access node 1100 may be, for example, a base station 1002 or 1006 or a network node that implements all or part of the functionality of the base station 1002 or gNB described herein. As illustrated, the radio access node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the radio access node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of a radio access node 1100 as described herein. In some embodiments, the function(s) are implemented in software that is stored, e.g., in the memory 1106 and executed by the one or more processors 1104.

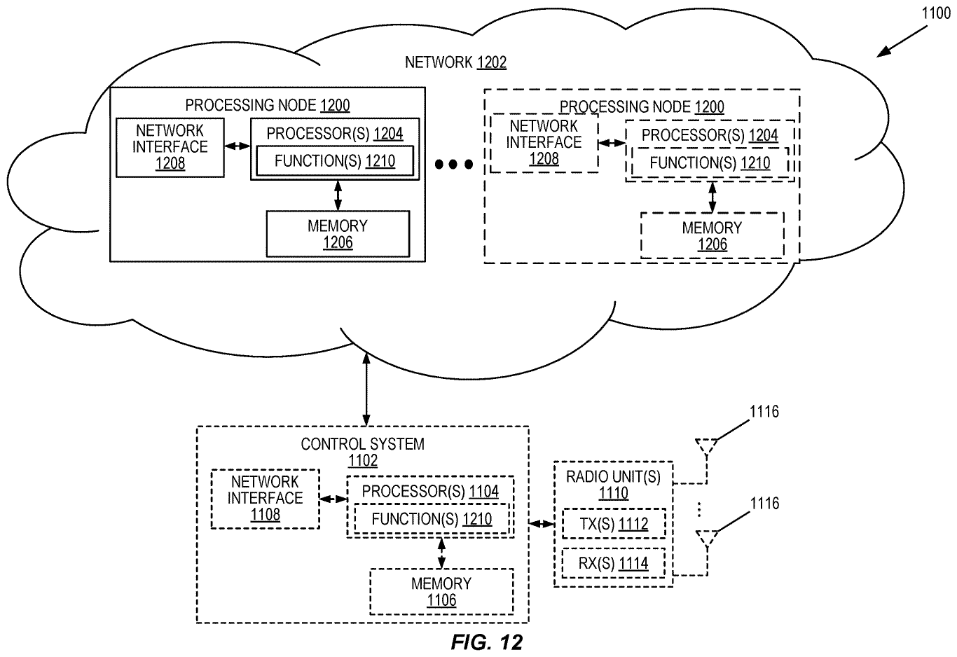

FIG. 12 is a schematic block diagram that illustrates a virtualized embodiment of the radio access node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1100 in which at least a portion of the functionality of the radio access node 1100 is implemented as a virtual component(s) (e.g., via a virtual machine(s) executing on a physical processing node(s) in a network(s)). As illustrated, in this example, the radio access node 1100 may include the control system 1102 and/or the one or more radio units 1110, as described above. The control system 1102 may be connected to the radio unit(s) 1110 via, for example, an optical cable or the like. The radio access node 1100 includes one or more processing nodes 1200 coupled to or included as part of a network(s) 1202. If present, the control system 1102 or the radio unit(s) are connected to the processing node(s) 1200 via the network 1202. Each processing node 1200 includes one or more processors 1204 (e.g., CPUs, ASICs, FPGAs, and/or the like), memory 1206, and a network interface 1208.

In this example, functions 1210 of the radio access node 1100 described herein are implemented at the one or more processing nodes 1200 or distributed across the one or more processing nodes 1200 and the control system 1102 and/or the radio unit(s) 1110 in any desired manner. In some particular embodiments, some or all of the functions 1210 of the radio access node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of radio access node 1100 or a node (e.g., a processing node 1200) implementing one or more of the functions 1210 of the radio access node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the radio access node 1100 according to some other embodiments of the present disclosure. The radio access node 1100 includes one or more modules 1300, each of which is implemented in software. The module(s) 1300 provide the functionality of the radio access node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

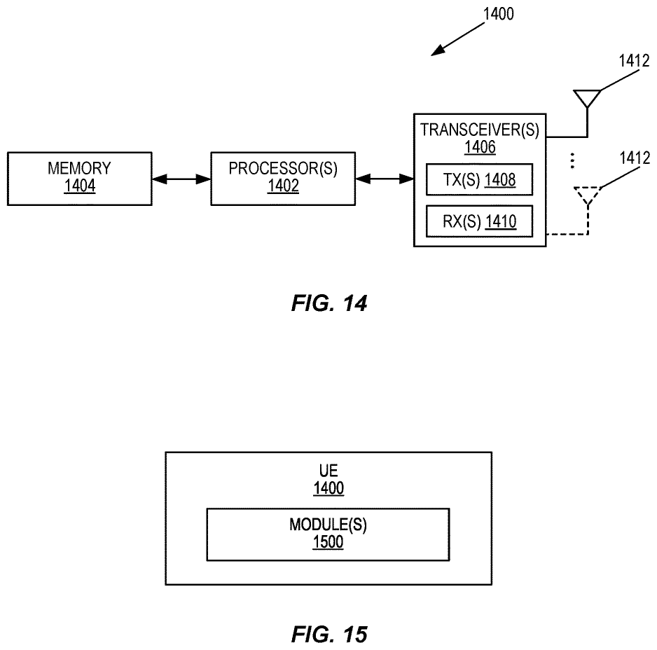

FIG. 14 is a schematic block diagram of a UE 1400 according to some embodiments of the present disclosure. As illustrated, the UE 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the UE 1400 described above may be fully or partially implemented in software that is, e.g., stored in the memory 1404 and executed by the processor(s) 1402. Note that the UE 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the UE 1400 and/or allowing output of information from the UE 1400), a power supply (e.g., a battery and associated power circuitry), etc.

In some embodiments, a computer program including instructions which, when executed by at least one processor, causes the at least one processor to carry out the functionality of the UE 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the UE 1400 according to some other embodiments of the present disclosure. The UE 1400 includes one or more modules 1500, each of which is implemented in software. The module(s) 1500 provide the functionality of the UE 1400 described herein.

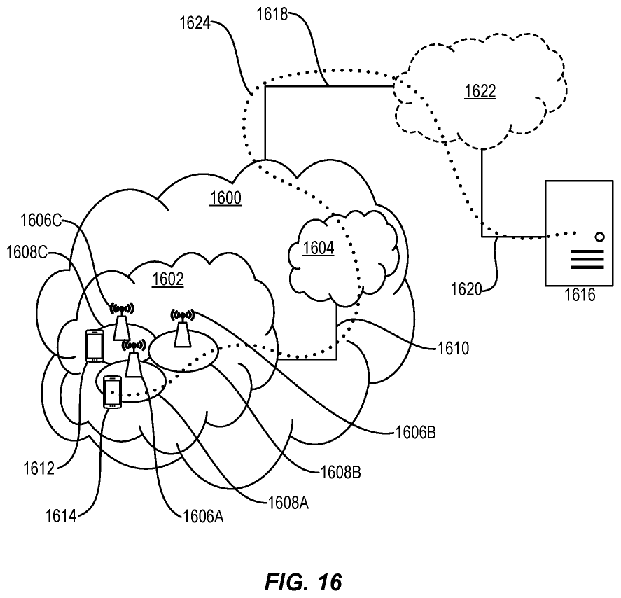

With reference to FIG. 16, in accordance with an embodiment, a communication system includes a telecommunication network 1600, such as a 3GPP-type cellular network, which comprises an access network 1602, such as a RAN, and a core network 1604. The access network 1602 comprises a plurality of base stations 1606A, 1606B, 1606C, such as Node Bs, eNBs, gNBs, or other types of wireless Access Points (APs), each defining a corresponding coverage area 1608A, 1608B, 1608C. Each base station 1606A, 1606B, 1606C is connectable to the core network 1604 over a wired or wireless connection 1610. A first UE 1612 located in coverage area 1608C is configured to wirelessly connect to, or be paged by, the corresponding base station 1606C. A second UE 1614 in coverage area 1608A is wirelessly connectable to the corresponding base station 1606A. While a plurality of UEs 1612, 1614 are illustrated in this example, the disclosed embodiments are equally applicable to a situation where a sole UE is in the coverage area or where a sole UE is connecting to the corresponding base station 1606.

The telecommunication network 1600 is itself connected to a host computer 1616, which may be embodied in the hardware and/or software of a standalone server, a cloud-implemented server, a distributed server, or as processing resources in a server farm. The host computer 1616 may be under the ownership or control of a service provider, or may be operated by the service provider or on behalf of the service provider. Connections 1618 and 1620 between the telecommunication network 1600 and the host computer 1616 may extend directly from the core network 1604 to the host computer 1616 or may go via an optional intermediate network 1622. The intermediate network 1622 may be one of, or a combination of more than one of, a public, private, or hosted network; the intermediate network 1622, if any, may be a backbone network or the Internet; in particular, the intermediate network 1622 may comprise two or more sub-networks (not shown).

The communication system of FIG. 16 as a whole enables connectivity between the connected UEs 1612, 1614 and the host computer 1616. The connectivity may be described as an Over-the-Top (OTT) connection 1624. The host computer 1616 and the connected UEs 1612, 1614 are configured to communicate data and/or signaling via the OTT connection 1624, using the access network 1602, the core network 1604, any intermediate network 1622, and possible further infrastructure (not shown) as intermediaries. The OTT connection 1624 may be transparent in the sense that the participating communication devices through which the OTT connection 1624 passes are unaware of routing of uplink and downlink communications. For example, the base station 1606 may not or need not be informed about the past routing of an incoming downlink communication with data originating from the host computer 1616 to be forwarded (e.g., handed over) to a connected UE 1612. Similarly, the base station 1606 need not be aware of the future routing of an outgoing uplink communication originating from the UE 1612 towards the host computer 1616.

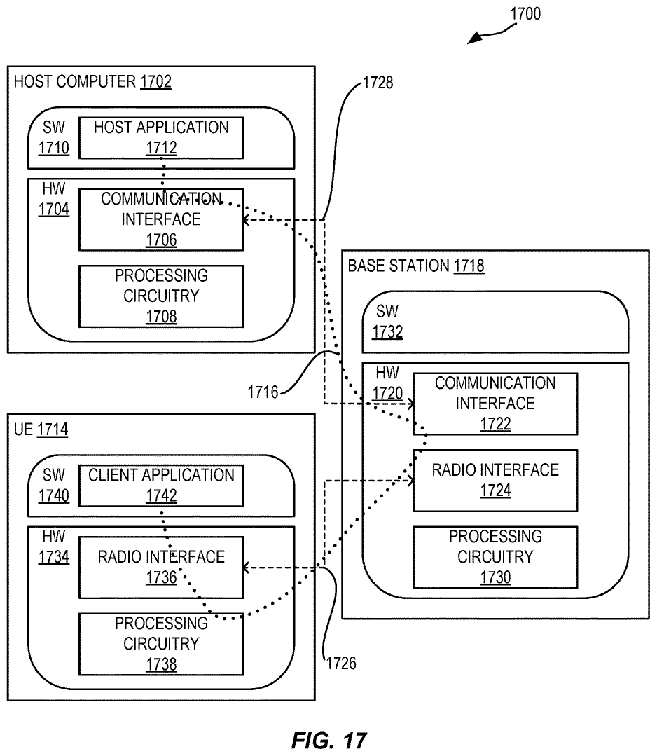

Example implementations, in accordance with an embodiment, of the UE, base station, and host computer discussed in the preceding paragraphs will now be described with reference to FIG. 17. In a communication system 1700, a host computer 1702 comprises hardware 1704 including a communication interface 1706 configured to set up and maintain a wired or wireless connection with an interface of a different communication device of the communication system 1700. The host computer 1702 further comprises processing circuitry 1708, which may have storage and/or processing capabilities. In particular, the processing circuitry 1708 may comprise one or more programmable processors, ASICs, FPGAs, or combinations of these (not shown) adapted to execute instructions. The host computer 1702 further comprises software 1710, which is stored in or accessible by the host computer 1702 and executable by the processing circuitry 1708. The software 1710 includes a host application 1712. The host application 1712 may be operable to provide a service to a remote user, such as a UE 1714 connecting via an OTT connection 1716 terminating at the UE 1714 and the host computer 1702. In providing the service to the remote user, the host application 1712 may provide user data which is transmitted using the OTT connection 1716.

The communication system 1700 further includes a base station 1718 provided in a telecommunication system and comprising hardware 1720 enabling it to communicate with the host computer 1702 and with the UE 1714. The hardware 1720 may include a communication interface 1722 for setting up and maintaining a wired or wireless connection with an interface of a different communication device of the communication system 1700, as well as a radio interface 1724 for setting up and maintaining at least a wireless connection 1726 with the UE 1714 located in a coverage area (not shown in FIG. 17) served by the base station 1718. The communication interface 1722 may be configured to facilitate a connection 1728 to the host computer 1702. The connection 1728 may be direct or it may pass through a core network (not shown in FIG. 17) of the telecommunication system and/or through one or more intermediate networks outside the telecommunication system. In the embodiment shown, the hardware 1720 of the base station 1718 further includes processing circuitry 1730, which may comprise one or more programmable processors, ASICs, FPGAs, or combinations of these (not shown) adapted to execute instructions. The base station 1718 further has software 1732 stored internally or accessible via an external connection.

The communication system 1700 further includes the UE 1714 already referred to. The UE's 1714 hardware 1734 may include a radio interface 1736 configured to set up and maintain a wireless connection 1726 with a base station serving a coverage area in which the UE 1714 is currently located. The hardware 1734 of the UE 1714 further includes processing circuitry 1738, which may comprise one or more programmable processors, ASICs, FPGAs, or combinations of these (not shown) adapted to execute instructions. The UE 1714 further comprises software 1740, which is stored in or accessible by the UE 1714 and executable by the processing circuitry 1738. The software 1740 includes a client application 1742. The client application 1742 may be operable to provide a service to a human or non-human user via the UE 1714, with the support of the host computer 1702. In the host computer 1702, the executing host application 1712 may communicate with the executing client application 1742 via the OTT connection 1716 terminating at the UE 1714 and the host computer 1702. In providing the service to the user, the client application 1742 may receive request data from the host application 1712 and provide user data in response to the request data. The OTT connection 1716 may transfer both the request data and the user data. The client application 1742 may interact with the user to generate the user data that it provides.

It is noted that the host computer 1702, the base station 1718, and the UE 1714 illustrated in FIG. 17 may be similar or identical to the host computer 1616, one of the base stations 1606A, 1606B, 1606C, and one of the UEs 1612, 1614 of FIG. 16, respectively. This is to say, the inner workings of these entities may be as shown in FIG. 17 and independently, the surrounding network topology may be that of FIG. 16.

In FIG. 17, the OTT connection 1716 has been drawn abstractly to illustrate the communication between the host computer 1702 and the UE 1714 via the base station 1718 without explicit reference to any intermediary devices and the precise routing of messages via these devices. The network infrastructure may determine the routing, which may be configured to hide from the UE 1714 or from the service provider operating the host computer 1702, or both. While the OTT connection 1716 is active, the network infrastructure may further take decisions by which it dynamically changes the routing (e.g., on the basis of load balancing consideration or reconfiguration of the network).

The wireless connection 1726 between the UE 1714 and the base station 1718 is in accordance with the teachings of the embodiments described throughout this disclosure. One or more of the various embodiments improve the performance of OTT services provided to the UE 1714 using the OTT connection 1716, in which the wireless connection 1726 forms the last segment.

A measurement procedure may be provided for the purpose of monitoring data rate, latency, and other factors on which the one or more embodiments improve. There may further be an optional network functionality for reconfiguring the OTT connection 1716 between the host computer 1702 and the UE 1714, in response to variations in the measurement results. The measurement procedure and/or the network functionality for reconfiguring the OTT connection 1716 may be implemented in the software 1710 and the hardware 1704 of the host computer 1702 or in the software 1740 and the hardware 1734 of the UE 1714, or both. In some embodiments, sensors (not shown) may be deployed in or in association with communication devices through which the OTT connection 1716 passes; the sensors may participate in the measurement procedure by supplying values of the monitored quantities exemplified above, or supplying values of other physical quantities from which the software 1710, 1740 may compute or estimate the monitored quantities. The reconfiguring of the OTT connection 1716 may include message format, retransmission settings, preferred routing, etc.; the reconfiguring need not affect the base station 1718, and it may be unknown or imperceptible to the base station 1718. Such procedures and functionalities may be known and practiced in the art. In certain embodiments, measurements may involve proprietary UE signaling facilitating the host computer's 1702 measurements of throughput, propagation times, latency, and the like. The measurements may be implemented in that the software 1710 and 1740 causes messages to be transmitted, in particular empty or ‘dummy’ messages, using the OTT connection 1716 while it monitors propagation times, errors, etc.

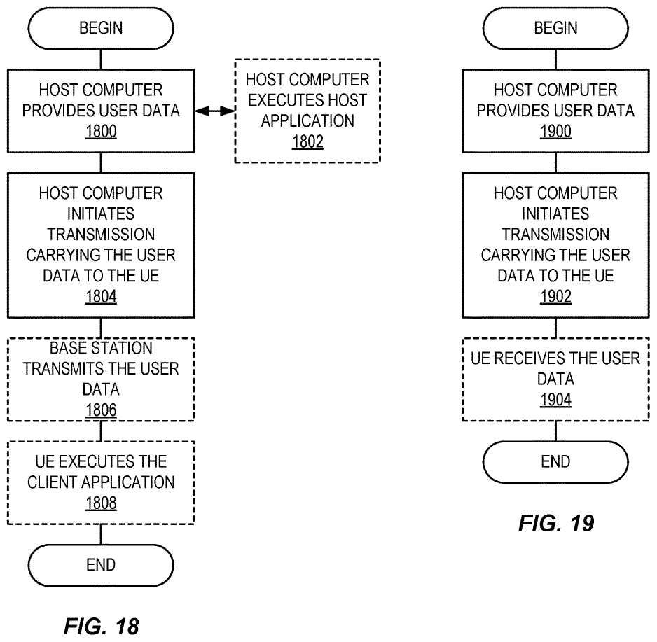

FIG. 18 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 18 will be included in this section. In step 1800, the host computer provides user data. In sub-step 1802 (which may be optional) of step 1800, the host computer provides the user data by executing a host application. In step 1804, the host computer initiates a transmission carrying the user data to the UE. In step 1806 (which may be optional), the base station transmits to the UE the user data which was carried in the transmission that the host computer initiated, in accordance with the teachings of the embodiments described throughout this disclosure. In step 1808 (which may also be optional), the UE executes a client application associated with the host application executed by the host computer.

FIG. 19 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 19 will be included in this section. In step 1900 of the method, the host computer provides user data. In an optional sub-step (not shown) the host computer provides the user data by executing a host application. In step 1902, the host computer initiates a transmission carrying the user data to the UE. The transmission may pass via the base station, in accordance with the teachings of the embodiments described throughout this disclosure. In step 1904 (which may be optional), the UE receives the user data carried in the transmission.

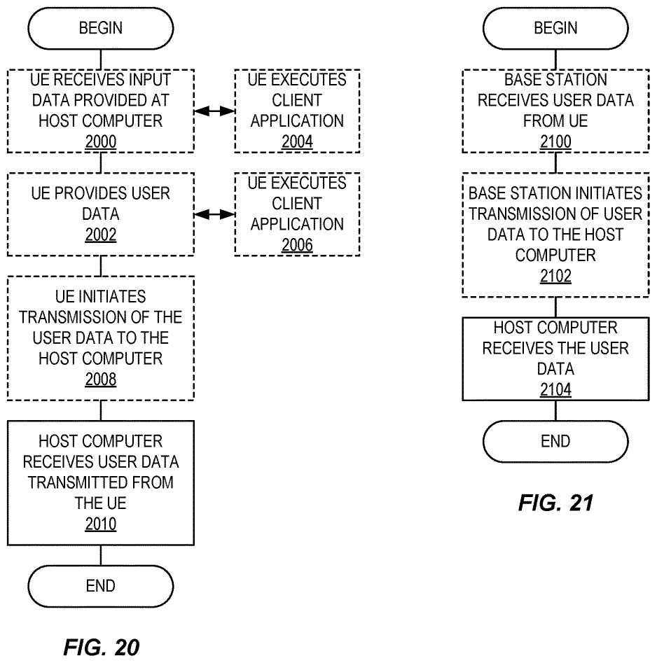

FIG. 20 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 20 will be included in this section. In step 2000 (which may be optional), the UE receives input data provided by the host computer. Additionally, or alternatively, in step 2002, the UE provides user data. In sub-step 2004 (which may be optional) of step 2000, the UE provides the user data by executing a client application. In sub-step 2006 (which may be optional) of step 2002, the UE executes a client application which provides the user data in reaction to the received input data provided by the host computer. In providing the user data, the executed client application may further consider user input received from the user. Regardless of the specific manner in which the user data was provided, the UE initiates, in sub-step 2008 (which may be optional), transmission of the user data to the host computer. In step 2010 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 21 will be included in this section. In step 2100 (which may be optional), in accordance with the teachings of the embodiments described throughout this disclosure, the base station receives user data from the UE. In step 2102 (which may be optional), the base station initiates transmission of the received user data to the host computer. In step 2104 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc.

Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by a User Equipment, UE, comprising: sending (100; 220; 310), to a network node, information that indicates one or more UE-associated types of available Artificial Intelligence, AI, or Machine Learning, ML, assistance information available from the UE.

Embodiment 2: The method of embodiment 1 further comprising receiving (102), from a network node, a request to provide UE-associated AI or ML assistance information within at least one of the one or more UE-associated types of available AI or ML assistance information.

Embodiment 3: The method of embodiment 2 further comprising, responsive to receiving (102) the request, sending (104) the requested UE-associated AI or ML assistance information to the network node.

Embodiment 4: The method of any of embodiments 1 to 3 wherein the one or more UE-associated types of available AI or ML assistance information comprises one or more of the following:
information that indicates that the UE is able to provide one or more certain predictions
information that indicates that the UE is able to support providing training data for an AI/ML model
information that indicates that the UE is able to support training or re-training an AI/ML model
information that indicates that the UE is able to support validating (or participate in validating) an AI/ML model
information that indicates that the UE is able to support authenticating (or participate in authenticating) an AI/ML model
information that indicates that the UE is able to support participating in executing an AI/ML model
information that indicates that the UE is able to support (up to) a certain number of hidden layers in neural network AI/ML models
information that indicates that the UE is able to support providing a certain number (e.g., a maximum number) of hidden units/nodes per hidden layer of the for a certain type of AI/ML model
information that indicates that the UE is able to support specific types of AI/ML models (e.g., feed-forward neural networks, convolutional neural networks, recurrent neural networks, graph neural networks, attention models, autoencoders, etc.)
information that indicates that the UE is able to support specific types of AI/ML algorithms (e.g., supervised learning, unsupervised learning, reinforcement learning, federated learning, etc.)
information that indicates that the UE is able to support certain AI/ML use cases or AI/ML based network operations
information that indicates that the UE is able to support joint AI/ML operation between the UE and a network node
information that indicates that the UE is able to support certain collaboration levels between the UE and a network node
information that indicates that the UE is able to support certain AI/ML model training strategy(ies)
information that indicates that the UE is able to support partial AI/ML model training at UE side or network side
information that indicates that the UE is able to support inference of certain information
information that indicates that the UE is able to support use of certain inferred information
information that indicates that the UE is able to support periodic/aperiodic feedback assistance information (e.g., for AI/ML model monitoring)
information that indicates that the UE is able to support testing Life Cycle Management (LCM)
information that indicates that the UE is able to support LCM procedures such as: activation/deactivation of AI/ML model, switching between AI/ML models, fallback to one AI/ML model, registration of an AI/ML model, updates of an AI/ML model
information that indicates that the UE is able to support operations/procedures/functionalities related to AI/ML at UE Access Stratum
information that indicates that the UE is able to support operations/procedures/functionalities related to AI/ML at UE Non-Access Stratum
information that indicates that the UE is able to support operations/procedures/functionalities related to AI/ML at UE Application layer
information that indicates that the UE is able to support providing feedback for an action triggered/recommended by an AI/ML model
information that indicates that the UE is able to support providing positioning labels in relation to AI/ML data samples
information that indicates that the UE is able to support providing timestamps labels in relation to AI/ML data samples.

Embodiment 5: The method of any of embodiments 1 to 4 wherein sending (100; 220; 310) the information that indicates the one or more UE-associated types of available AI or ML assistance information comprises sending the information in one or more Radio Resource Control, RRC, messages.

Embodiment 6: The method of embodiment 5 wherein the one or more RRC messages comprise one or more of the following: an RRCResumeComplete message, an RRCSetupComplete message, an RRCReconfigurationComplete message, an RRCReestablishmentComplete message, an UECapabilityInformation message, an UplinkInformationTransfer message, an UEInformationResponse message, an UEAssistanceInformation message, a MeasurementReport message, a MeasurementReportAppLayer message, and/or an Uplinkinformation TransferMRDC message.

Embodiment 7: The method of any of embodiments 1 to 6 further comprising: receiving (210; 300), from the network node, a request for the information that indicates the one or more UE-associated types of available AI or ML assistance information; wherein sending (220; 310) the information that indicates the one or more UE-associated types of available AI or ML assistance information comprise sending (220) the information to the network node in response to receiving (210; 300) the request.

Embodiment 8: The method of any of embodiments 1 or 4 further comprising sending (200), to the network node, an indication of availability of the information that indicates the one or more UE-associated types of available AI or ML assistance information.

Embodiment 9: The method of embodiment 8 wherein sending (200) the indication comprises sending (200) the indication comprised in an uplink message of an RRC Connection Establishment procedure, an RRC Connection Resume procedure, an RRC Connection Re-establishment procedure, an RRC Connection Reconfiguration procedure, a Measurement Report procedure, an Application layer measurement reporting procedure, a UE Information procedure, an UL Information Transfer procedure, an UL information transfer for MR-DC procedure, a UE Capability transfer procedure, or a UE Assistance Information procedure.

Embodiment 10: The method of embodiment 8 or 9 wherein sending (200) the indication comprises sending (200) the indication comprised in an RRC message, such as an RRCResumeComplete message, an RRCResumeRequest message, an RRCSetupComplete message, an RRCSetupRequest message, an RRCReconfigurationComplete message, an RRCReestablishmentComplete message, an UECapabilityInformation message, and UplinkInformationTransfer message, an UEInformationResponse message, an UEAssistanceInformation message, a MeasurementReport message, a MeasurementReportAppLayer message, or an UplinkInformationTransferMRDC message.

Embodiment 11: The method of any of embodiments 1 to 10 further comprising: receiving (620), from a second network node, a request for the information that indicates the one or more UE-associated types of available AI or ML assistance information; and sending (630) the information that indicates the one or more UE-associated types of available AI or ML assistance information to the second network node in response to receiving (620) the request from the second network node.

Embodiment 12: The method of any of embodiments 1 to 10 further comprising: sending (740) the information that indicates the one or more UE-associated types of available AI or ML assistance information to a second network node.

Embodiment 13: A User Equipment, UE, adapted to perform the method of any of embodiments 1 to 12.

Embodiment 14: A method performed by a first network node, comprising: receiving (100; 220; 310) from a User Equipment, UE, information that indicates one or more UE-associated types of available Artificial Intelligence, AI, or Machine Learning, ML, assistance information that are available from the UE.

Embodiment 15: The method of embodiment 14 further comprising sending (102), to the UE, a request to provide UE-associated AI or ML assistance information within at least one of the one or more UE-associated types of available AI or ML assistance information.

Embodiment 16: The method of embodiment 15 further comprising, responsive to sending (102) the request, receiving (104) the requested UE-associated AI or ML assistance information from the UE.

Embodiment 17: The method of any of embodiments 14 to 16 wherein the one or more UE-associated types of available AI or ML assistance information comprises one or more of the following:
information that indicates that the UE is able to provide one or more certain predictions
information that indicates that the UE is able to support providing training data for an AI/ML model
information that indicates that the UE is able to support training or re-training an AI/ML model
information that indicates that the UE is able to support validating (or participate in validating) an AI/ML model
information that indicates that the UE is able to support authenticating (or participate in authenticating) an AI/ML model
information that indicates that the UE is able to support participating in executing an AI/ML model
information that indicates that the UE is able to support (up to) a certain number of hidden layers in neural network AI/ML models
information that indicates that the UE is able to support providing a certain number (e.g., a maximum number) of hidden units/nodes per hidden layer of the for a certain type of AI/ML model
information that indicates that the UE is able to support specific types of AI/ML models (e.g., feed-forward neural networks, convolutional neural networks, recurrent neural networks, graph neural networks, attention models, autoencoders, etc.)
information that indicates that the UE is able to support specific types of AI/ML algorithms (e.g., supervised learning, unsupervised learning, reinforcement learning, federated learning, etc.)
information that indicates that the UE is able to support certain AI/ML use cases or AI/ML based network operations
information that indicates that the UE is able to support joint AI/ML operation between the UE and a network node
information that indicates that the UE is able to support certain collaboration levels between the UE and a network node
information that indicates that the UE is able to support certain AI/ML model training strategy(ies)
information that indicates that the UE is able to support partial AI/ML model training at UE side or network side
information that indicates that the UE is able to support inference of certain information
information that indicates that the UE is able to support use of certain inferred information
information that indicates that the UE is able to support periodic/aperiodic feedback assistance information (e.g., for AI/ML model monitoring)
information that indicates that the UE is able to support testing Life Cycle Management (LCM)
information that indicates that the UE is able to support LCM procedures such as: activation/deactivation of AI/ML model, switching between AI/ML models, fallback to one AI/ML model, registration of an AI/ML model, updates of an AI/ML model
information that indicates that the UE is able to support operations/procedures/functionalities related to AI/ML at UE Access Stratum
information that indicates that the UE is able to support operations/procedures/functionalities related to AI/ML at UE Non-Access Stratum
information that indicates that the UE is able to support operations/procedures/functionalities related to AI/ML at UE Application layer
information that indicates that the UE is able to support providing feedback for an action triggered/recommended by an AI/ML model
information that indicates that the UE is able to support providing positioning labels in relation to AI/ML data samples
information that indicates that the UE is able to support providing timestamps labels in relation to AI/ML data samples.

Embodiment 18: The method of any of embodiments 14 to 17 wherein receiving (100; 220; 310) the information that indicates the one or more UE-associated types of available AI or ML assistance information comprises receiving the information in one or more Radio Resource Control, RRC, messages.

Embodiment 19: The method of embodiment 18 wherein the one or more RRC messages comprise one or more of the following: an RRCResumeComplete message, an RRCSetupComplete message, an RRCReconfigurationComplete message, an RRCReestablishmentComplete message, an UECapabilityInformation message, an UplinkInformationTransfer message, an UEInformationResponse message, an UEAssistanceInformation message, a MeasurementReport message, a MeasurementReportAppLayer message, and/or an Uplink Information Transfer MR-DC message.

Embodiment 20: The method of any of embodiments 14 to 19 further comprising: sending (210; 300), to the UE, a request for the information that indicates the one or more UE-associated types of available AI or ML assistance information; wherein receiving (220; 310) the information that indicates the one or more UE-associated types of available AI or ML assistance information comprise receiving (220) the information from the UE in response to sending (210; 300) the request.

Embodiment 21: The method of embodiment 14 or 17 further comprising receiving (200), from the UE, an indication of availability of the information that indicates the one or more UE-associated types of available AI or ML assistance information.

Embodiment 22: The method of embodiment 21 wherein receiving (200) the indication comprises receiving (200) the indication comprised in an uplink message of an RRC Connection Establishment procedure, an RRC Connection Resume procedure, an RRC Connection Re-establishment procedure, an RRC Connection Reconfiguration procedure, a Measurement Report procedure, an Application layer measurement reporting procedure, a UE Information procedure, an UL Information Transfer procedure, an UL information transfer for MR-DC procedure, a UE Capability transfer procedure, or a UE Assistance Information procedure.

Embodiment 23: The method of embodiment 21 or 22 wherein receiving (200) the indication comprises receiving (200) the indication comprised in an RRC message, such as an RRCResumeComplete message, an RRCResumeRequest message, an RRCSetupComplete message, an RRCSetupRequest message, an RRCReconfigurationComplete message, an RRCReestablishmentComplete message, an UECapabilityInformation message, and UplinkinformationTransfer message, an UEInformationResponse message, an UEAssistanceInformation message, a MeasurementReport message, a MeasurementReportAppLayer message, or an UplinkInformationTransferMRDC message.

Embodiment 24: The method of any of embodiments 14 to 23 further comprising sending (400; 520), to a second network node, the information that indicates the one or more UE-associated types of available AI or ML assistance information available from the UE.

Embodiment 25: The method of embodiment 24 further comprising: receiving (510), from the second network node, a request for the information that indicates the one or more UE-associated types of available AI or ML assistance information; wherein sending (520) the information that indicates the one or more UE-associated types of available AI or ML assistance information to the second network node comprises sending (520) the information that indicates the one or more UE-associated types of available AI or ML assistance information to the second network node in response to receiving (510) the request from the second network node.

Embodiment 26: The method of embodiment 25 further comprising sending (500), to the second network node, an indication of availability of the information that indicates the one or more UE-associated types of available AI or ML assistance information.

Embodiment 27: The method of any of embodiments 14 to 23 further comprising: sending (600; 700; 800), to a second network node during a mobility, or conditional mobility, or multi-connectivity for the UE, a message (e.g., a handover request message) comprising an indication of availability of the information that indicates the one or more UE-associated types of available AI or ML assistance information available from the UE.

Embodiment 28: The method of embodiment 27 further comprising receiving (710), from the second network node, a second message (e.g., handover acknowledgement message) comprising a request for the information that indicates the one or more UE-associated types of available AI or ML assistance information available from the UE.

Embodiment 29: A first network node adapted to perform the method of any of embodiments 14 to 28.

Embodiment 30: A method performed by a second network node, comprising: receiving (400; 520), from a first network node, information that indicates one or more User Equipment, UE-associated types of available Artificial Intelligence, AI, or Machine Learning, ML, assistance information that are available from a UE.

Embodiment 31: The method of embodiment 30 wherein the one or more UE-associated types of available AI or ML assistance information comprises one or more of the following:
information that indicates that the UE is able to provide one or more certain predictions
information that indicates that the UE is able to support providing training data for an AI/ML model
information that indicates that the UE is able to support training or re-training an AI/ML model
information that indicates that the UE is able to support validating (or participate in validating) an AI/ML model
information that indicates that the UE is able to support authenticating (or participate in authenticating) an AI/ML model
information that indicates that the UE is able to support participating in executing an AI/ML model
information that indicates that the UE is able to support (up to) a certain number of hidden layers in neural network AI/ML models
information that indicates that the UE is able to support providing a certain number (e.g., a maximum number) of hidden units/nodes per hidden layer of the for a certain type of AI/ML model
information that indicates that the UE is able to support specific types of AI/ML models (e.g., feed-forward neural networks, convolutional neural networks, recurrent neural networks, graph neural networks, attention models, autoencoders, etc.)
information that indicates that the UE is able to support specific types of AI/ML algorithms (e.g., supervised learning, unsupervised learning, reinforcement learning, federated learning, etc.)
information that indicates that the UE is able to support certain AI/ML use cases or AI/ML based network operations
information that indicates that the UE is able to support joint AI/ML operation between the UE and a network node
information that indicates that the UE is able to support certain collaboration levels between the UE and a network node
information that indicates that the UE is able to support certain AI/ML model training strategy(ies)
information that indicates that the UE is able to support partial AI/ML model training at UE side or network side
information that indicates that the UE is able to support inference of certain information
information that indicates that the UE is able to support use of certain inferred information
information that indicates that the UE is able to support periodic/aperiodic feedback assistance information (e.g., for AI/ML model monitoring)
information that indicates that the UE is able to support testing Life Cycle Management (LCM)
information that indicates that the UE is able to support LCM procedures such as: activation/deactivation of AI/ML model, switching between AI/ML models, fallback to one AI/ML model, registration of an AI/ML model, updates of an AI/ML model
information that indicates that the UE is able to support operations/procedures/functionalities related to AI/ML at UE Access Stratum
information that indicates that the UE is able to support operations/procedures/functionalities related to AI/ML at UE Non-Access Stratum
information that indicates that the UE is able to support operations/procedures/functionalities related to AI/ML at UE Application layer
information that indicates that the UE is able to support providing feedback for an action triggered/recommended by an AI/ML model
information that indicates that the UE is able to support providing positioning labels in relation to AI/ML data samples
information that indicates that the UE is able to support providing timestamps labels in relation to AI/ML data samples.

Embodiment 32: The method of embodiment 30 or 31 further comprising: sending (510), to the first network node, a request for the information that indicates the one or more UE-associated types of available AI or ML assistance information; wherein receiving (520) the information that indicates the one or more UE-associated types of available AI or ML assistance information comprise receiving (520) the information from the first network node in response to sending (510) the request.

Embodiment 33: The method of embodiment 32 further comprising receiving (500), from the first network node, an indication of availability of the information that indicates the one or more UE-associated types of available AI or ML assistance information that are available from the UE.

Embodiment 34: A method performed by a second network node, comprising: receiving (600; 700; 800), from a first network node during a mobility, or conditional mobility, or multi-connectivity procedure for a UE, an indication of availability of information that indicates one or more User Equipment, UE-associated types of available Artificial Intelligence, AI, or Machine Learning, ML, assistance information that are available from a UE.

Embodiment 35: The method of embodiment 34 further comprising, prior to receiving the indication, sending to the first network node, during the mobility, or conditional mobility, or multi-connectivity procedure for the UE, a request for the information that indicates the one or more UE-associated types of available AI or ML assistance information that are available from a UE.

Embodiment 36: A method performed by a second network node, comprising: receiving (600), from a first network node during a mobility, or conditional mobility, or multi-connectivity procedure for a UE, an indication of availability of information that indicates one or more User Equipment, UE-associated types of available Artificial Intelligence, AI, or Machine Learning, ML, assistance information that are available from a UE; and sending (620), to the UE, a request for UE-associated types of available Artificial Intelligence, AI, or Machine Learning, ML, assistance information that are available from the UE.

Embodiment 37: The method of any of embodiments 34 or 35 wherein the one or more UE-associated types of available AI or ML assistance information comprises one or more of the following:
information that indicates that the UE is able to provide one or more certain predictions
information that indicates that the UE is able to support providing training data for an AI/ML model
information that indicates that the UE is able to support training or re-training an AI/ML model
information that indicates that the UE is able to support validating (or participate in validating) an AI/ML model
information that indicates that the UE is able to support authenticating (or participate in authenticating) an AI/ML model
information that indicates that the UE is able to support participating in executing an AI/ML model
information that indicates that the UE is able to support (up to) a certain number of hidden layers in neural network AI/ML models
information that indicates that the UE is able to support providing a certain number (e.g., a maximum number) of hidden units/nodes per hidden layer of the for a certain type of AI/ML model
information that indicates that the UE is able to support specific types of AI/ML models (e.g., feed-forward neural networks, convolutional neural networks, recurrent neural networks, graph neural networks, attention models, autoencoders, etc.)
information that indicates that the UE is able to support specific types of AI/ML algorithms (e.g., supervised learning, unsupervised learning, reinforcement learning, federated learning, etc.)
information that indicates that the UE is able to support certain AI/ML use cases or AI/ML based network operations
information that indicates that the UE is able to support joint AI/ML operation between the UE and a network node
information that indicates that the UE is able to support certain collaboration levels between the UE and a network node
information that indicates that the UE is able to support certain AI/ML model training strategy(ies)
information that indicates that the UE is able to support partial AI/ML model training at UE side or network side
information that indicates that the UE is able to support inference of certain information
information that indicates that the UE is able to support use of certain inferred information
information that indicates that the UE is able to support periodic/aperiodic feedback assistance information (e.g., for AI/ML model monitoring)
information that indicates that the UE is able to support testing Life Cycle Management (LCM)
information that indicates that the UE is able to support LCM procedures such as: activation/deactivation of AI/ML model, switching between AI/ML models, fallback to one AI/ML model, registration of an AI/ML model, updates of an AI/ML model
information that indicates that the UE is able to support operations/procedures/functionalities related to AI/ML at UE Access Stratum
information that indicates that the UE is able to support operations/procedures/functionalities related to AI/ML at UE Non-Access Stratum
information that indicates that the UE is able to support operations/procedures/functionalities related to AI/ML at UE Application layer
information that indicates that the UE is able to support providing feedback for an action triggered/recommended by an AI/ML model
information that indicates that the UE is able to support providing positioning labels in relation to AI/ML data samples
information that indicates that the UE is able to support providing timestamps labels in relation to AI/ML data samples.

Embodiment 38: The method of embodiment 34, 35, or 37 further comprising: sending (620), to the UE, a request for the information that indicates the one or more UE-associated types of available AI or ML assistance information available from the UE; and receiving (630) the information that indicates the one or more UE-associated types of available AI or ML assistance information from the UE in response to sending (620) the request.

Embodiment 39: The method of embodiment 34, 35, or 37 further comprising: sending (710), to the first network node, a message comprising a request for the information that indicates the one or more UE-associated types of available AI or ML assistance information available from the UE; and receiving (712) the information that indicates the one or more UE-associated types of available AI or ML assistance information from the UE in response to sending (710) the request.

Embodiment 40: A second network node adapted to perform the method of any of embodiments 30 to 39.

Those skilled in the art will recognize improvements and modifications to the embodiments of the present disclosure. All such improvements and modifications are considered within the scope of the concepts disclosed herein.

1. A method performed by a User Equipment (UE) comprising:
sending, to a network node, information that indicates one or more UE-associated types of available Artificial Intelligence (AI) Machine Learning (ML) assistance information available from the UE.

2. The method of claim 1, wherein the one or more UE-associated types of available AI or ML assistance information comprises one or more of the following:
information that indicates that the UE is able to provide one or more certain predictions;
information that indicates that the UE is able to support providing training data for an AI/ML model;
information that indicates that the UE is able to support training or re-training an AI/ML model;
information that indicates that the UE is able to support validating an AIML model or able to support participating in validation of an AI/ML model;
information that indicates that the UE is able to support authenticating an AI/ML model or able to support participating in authentication of an AI/ML model;
information that indicates that the UE is able to support participating in execution of an AI/ML model;
information that indicates that the UE is able to support up to a certain number of hidden layers in neural network AI/ML models;
information that indicates that the UE is able to support providing a certain number of hidden units or nodes per hidden layer for a certain type of AI/ML model;
information that indicates that the UE is able to support specific types of AI/ML models;
information that indicates that the UE is able to support specific types of AI/ML algorithms;
information that indicates that the UE is able to support certain AI/ML use cases or AI/ML based network operations;
information that indicates that the UE is able to support joint AI/ML operation between the UE and a network node;
information that indicates that the UE is able to support certain collaboration levels between the UE and a network node;
information that indicates that the UE is able to support certain AI/ML model training strategy;
information that indicates that the UE is able to support partial AI/ML model training at UE side or network side;
information that indicates that the UE is able to support inference of certain information;
information that indicates that the UE is able to support use of certain inferred information;
information that indicates that the UE is able to support periodic or aperiodic feedback assistance information;
information that indicates that the UE is able to support testing Life Cycle Management (LCM);
information that indicates that the UE is able to support LCM procedures such as: activation/deactivation of AI/ML model, switching between AI/ML models, fallback to one AI/ML model, registration of an AI/ML model, and/or updates of an AI/ML model;
information that indicates that the UE is able to support operations, procedures, or functionalities related to AI/ML at UE Access Stratum;
information that indicates that the UE is able to support operations, procedures, or functionalities related to AI/ML at UE Non-Access Stratum;
information that indicates that the UE is able to support operations, procedures, or functionalities related to AI/ML at UE Application layer;
information that indicates that the UE is able to support providing feedback for an action triggered or recommended by an AI/ML model;
information that indicates that the UE is able to support providing positioning labels in relation to AI/ML data samples; and
information that indicates that the UE is able to support providing timestamps labels in relation to AI/ML data samples.

3.-4. (canceled)

5. The method of claim 1, further comprising receiving, from a network node, a request to provide UE-associated AI or ML assistance information within at least one of the one or more UE-associated types of available AI or ML assistance information.

6. The method of claim 5, further comprising, responsive to receiving the request, sending the requested UE-associated AI or ML assistance information to the network node.

7. The method of claim 1, further comprising:
receiving, from the network node, a request for the information that indicates the one or more UE-associated types of available AI or ML assistance information;
wherein sending the information that indicates the one or more UE-associated types of available AI or ML assistance information comprise sending the information to the network node in response to receiving the request.

8. The method of claim 7, further comprising sending, to the network node, an indication of availability of the information that indicates the one or more UE-associated types of available AI or ML assistance information.

9.-10. (canceled)

11. The method of claim 1, further comprising:
receiving, from a second network node, a request for the information that indicates the one or more UE-associated types of available AI or ML assistance information; and
sending the information that indicates the one or more UE-associated types of available AI or ML assistance information available from the UE to the second network node in response to receiving the request from the second network node.

12. The method of claim 1, further comprising:
sending the information that indicates the one or more UE-associated types of available AI or ML assistance information to a second network node.

13.-16. (canceled)

17. A method performed by a first network node, comprising:
receiving from a User Equipment (UE) information that indicates one or more UE-associated types of available Artificial Intelligence (AI) or Machine Learning (ML) assistance information that are available from the UE.

18. The method of claim 17, wherein the one or more UE-associated types of available AI or ML assistance information comprises one or more of the following:
information that indicates that the UE is able to provide one or more certain predictions;
information that indicates that the UE is able to support providing training data for an AI/ML model;
information that indicates that the UE is able to support training or re-training an AI/ML model;
information that indicates that the UE is able to support validating an AIML model or able to support participating in validation of an AI/ML model;
information that indicates that the UE is able to support authenticating an AI/ML model or able to support participating in authentication of an AI/ML model;
information that indicates that the UE is able to support participating in execution of an AI/ML model;
information that indicates that the UE is able to support up to a certain number of hidden layers in neural network AI/ML models;
information that indicates that the UE is able to support providing a certain number of hidden units or nodes per hidden layer for a certain type of AI/ML model;
information that indicates that the UE is able to support specific types of AI/ML models;
information that indicates that the UE is able to support specific types of AI/ML algorithms;
information that indicates that the UE is able to support certain AI/ML use cases or AI/ML based network operations;
information that indicates that the UE is able to support joint AI/ML operation between the UE and a network node;
information that indicates that the UE is able to support certain collaboration levels between the UE and a network node;
information that indicates that the UE is able to support certain AI/ML model training strategy;
information that indicates that the UE is able to support partial AI/ML model training at UE side or network side;
information that indicates that the UE is able to support inference of certain information;
information that indicates that the UE is able to support use of certain inferred information;
information that indicates that the UE is able to support periodic or aperiodic feedback assistance information;
information that indicates that the UE is able to support testing Life Cycle Management (LCM);
information that indicates that the UE is able to support LCM procedures such as:
activation/deactivation of AI/ML model, switching between AI/ML models, fallback to one AI/ML model, registration of an AI/ML model, and/or updates of an AI/ML model;
information that indicates that the UE is able to support operations, procedures, or functionalities related to AI/ML at UE Access Stratum;
information that indicates that the UE is able to support operations, procedures, or functionalities related to AI/ML at UE Non-Access Stratum;
information that indicates that the UE is able to support operations, procedures, or functionalities related to AI/ML at UE Application layer;
information that indicates that the UE is able to support providing feedback for an action triggered or recommended by an AI/ML model;
information that indicates that the UE is able to support providing positioning labels in relation to AI/ML data samples; and
information that indicates that the UE is able to support providing timestamps labels in relation to AI/ML data samples.

19.-20. (canceled)

21. The method of claim 17, further comprising sending, to the UE, a request to provide UE-associated AI or ML assistance information within at least one of the one or more UE-associated types of available AI or ML assistance information.

22. The method of claim 21, further comprising, responsive to sending the request, receiving the requested UE-associated AI or ML assistance information from the UE.

23. The method of claim 17, further comprising:
sending, to the UE, a request for the information that indicates the one or more UE-associated types of available AI or ML assistance information;
wherein receiving the information that indicates the one or more UE-associated types of available AI or ML assistance information comprise receiving the information from the UE in response to sending the request.

24. The method of claim 23, further comprising receiving, from the UE, an indication of availability of the information that indicates the one or more UE-associated types of available AI or ML assistance information.

25.-26. (canceled)

25. The method of claim 17, further comprising sending, to a second network node, the information that indicates the one or more UE-associated types of available AI or ML assistance information available from the UE.

27. The method of claim 27, further comprising:
receiving, from the second network node, a request for the information that indicates the one or more UE-associated types of available AI or ML assistance information;
wherein sending the information that indicates the one or more UE-associated types of available AI or ML assistance information to the second network node comprises sending the information that indicates the one or more UE-associated types of available AI or ML assistance information to the second network node in response to receiving the request from the second network node.

28. The method of claim 28, further comprising sending, to the second network node, an indication of availability of the information that indicates the one or more UE-associated types of available AI or ML assistance information.

29. The method of claim 17, further comprising:
sending, to a second network node during a mobility, or conditional mobility, or multi-connectivity for the UE, a message (e.g., a handover request message) comprising an indication of availability of the information that indicates the one or more UE-associated types of available AI or ML assistance information available from the UE.

30. The method of claim 30, further comprising receiving, from the second network node, a second message (e.g., handover acknowledgement message) comprising a request for the information that indicates the one or more UE-associated types of available AI or ML assistance information available from the UE.

32.-35. (canceled)

36. A method performed by a second network node, comprising:
receiving, from a first network node, information that indicates one or more User Equipment (UE) associated types of available Artificial Intelligence (AI) or Machine Learning (ML) assistance information that are available from a UE.

37.-56. (canceled)
